(19) United States
(12) Patent Application Publication
(10) Pub. No.: US 2026/0252293 A1
(43) Pub. Date: Aug. 27, 2026

(54) FIRST IMAGE FORMING APPARATUS, SECOND IMAGE FORMING APPARATUS, AND PROCESSING METHOD

(71) Applicant: SEIKO EPSON CORPORATION, Tokyo (JP)

(72) Inventors: Akihiko SATOMI, Shiojir (JP); Yoshinori MATSUMURA, Matsumoto (JP); Hideharu ONISHI, Shiojiri (JP)

(21) Appl. No.: 19/549,070

(22) Filed: Feb. 25, 2026

(30) Foreign Application Priority Data
Feb. 27, 2025 (JP) 2025-029865

(51) Int. Cl. G06F 3/12

(52) U.S. Cl. CPC G06F 3/1261; G06F 3/1204; G06F 3/1205; G06F 3/1222; G06F 3/1238; G06F 3/1247; G06F 3/1291

(57) ABSTRACT

A first image forming apparatus includes a print data acquisition section, a change section, and a print data transmission section. The print data acquisition section acquires, from a terminal device, print data including any one of first band data divided with a first direction of a print target as a longitudinal direction or second band data divided with a second direction intersecting the first direction of the print target as the longitudinal direction. The change section performs change processing of the longitudinal direction of band data in the acquired print data. The print data transmission section transmits, to a second image forming apparatus, the print data subjected to the change processing of the longitudinal direction of the band data.

The present application is based on, and claims priority from JP Application Serial Number 2025-029865, filed February 27, 2025, the disclosure of which is hereby incorporated by reference herein in its entirety.

### BACKGROUND

### 1. Technical Field

The present disclosure relates to a first image forming apparatus, a second image forming apparatus, and a processing method.

### 2. Related Art

JP-A-2018-190146 discloses a print system. In the system according to JP-A-2018-190146, a print instruction device transmits data related to a print target document to a document storage device. A user selects, from among a plurality of image forming apparatuses, a print output device for which a print output is desired to be performed. Print data is acquired from the document storage device through a user authentication operation using an operation input section or the like of the print output device to perform the print output by the print output device.

In the technique described in JP-A-2018-190146, there is a concern that an appropriate print result may not be obtained when the printing output device acquires the print data from the document storage device. For this reason, convenience may be reduced.

### SUMMARY

According to an aspect of the present disclosure, there is provided a first image forming apparatus including a print data acquisition section that acquires, from a terminal device, print data including any one of first band data, which is divided with a first direction of a print target as a longitudinal direction, and second band data, which is divided with a second direction intersecting the first direction of the print target as the longitudinal direction, a change section that performs change processing of the longitudinal direction of band data in the acquired print data, and a print data transmission section that transmits, to a second image forming apparatus, the print data subjected to the change processing of the longitudinal direction of the band data.

According to another aspect of the present disclosure, there is provided a second image forming apparatus including an authentication section that executes authentication of a user, a print data acquisition section that acquires, when the authentication is successful, print data from a first image forming apparatus that acquires the print data from a terminal device or from the terminal device that transmits the print data to the first image forming apparatus, and a printing section that performs printing of the acquired print data, in which change processing based on a longitudinal direction of band data corresponding to the second image forming apparatus is performed on a longitudinal direction of band data in which a print target is divided, in the print data acquired by the print data acquisition section.

According to still another aspect of the present disclosure, there is provided a processing method executed by a first image forming apparatus, the processing method including acquiring, from a terminal device, print data including any one of first band data, which is divided with a first direction of a print target as a longitudinal direction, and second band data, which is divided with a second direction intersecting the first direction of the print target as the longitudinal direction, performing change processing of the longitudinal direction of band data in the acquired print data, and transmitting, to a second image forming apparatus, the print data subjected to the change processing of the longitudinal direction of the band data.

### BRIEF DESCRIPTION OF THE DRAWINGS

FIG. 1 is a diagram showing a processing system according to Embodiment 1.

FIG. 2 is a diagram for describing an outline of processing performed in the processing system according to Embodiment 1.

FIG. 3 is a diagram illustrating print original document data and print data according to Embodiment 1.

FIG. 4 is a diagram showing an example in which an image forming apparatus according to Embodiment 1 processes first band data to form an image on a print medium.

FIG. 5 is a diagram showing an example in which the image forming apparatus according to Embodiment 1 processes second band data to form an image on a print medium.

FIG. 6 is a diagram for describing a change function according to Embodiment 1.

FIG. 7 is a diagram showing a configuration of a terminal device according to Embodiment 1.

FIG. 8 is a diagram showing a configuration of a first image forming apparatus according to Embodiment 1.

FIG. 9 is a diagram showing a configuration of a second image forming apparatus according to Embodiment 1.

FIG. 10 is a diagram showing processing executed by the processing system according to Embodiment 1.

FIG. 11 is a diagram showing processing executed by the processing system according to Embodiment 1.

FIG. 12 is a diagram for describing differences between a comparative example and Embodiment 1.

FIG. 13 is a diagram for describing differences between a comparative example and Embodiment 1.

FIG. 14 is a diagram for describing differences between a comparative example and Embodiment 1.

FIG. 15 is a diagram for describing differences between a comparative example and Embodiment 1.

FIG. 16 is a diagram showing a configuration of the terminal device according to Embodiment 2.

FIG. 17 is a diagram showing a configuration of the second image forming apparatus according to Embodiment 2.

FIG. 18 is a diagram showing processing executed by the processing system according to Embodiment 2.

FIG. 19 is a diagram showing a configuration of the first image forming apparatus according to Embodiment 3.

FIG. 20 is a diagram illustrating a model table according to Embodiment 3.

FIG. 21 is a diagram showing processing executed by the processing system according to Embodiment 3.

FIG. 22 is a diagram showing a configuration of the first image forming apparatus according to a first modification example of Embodiment 3.

FIG. 23 is a diagram illustrating a submachine table according to the first modification example of Embodiment 3.

FIG. 24 is a diagram showing a configuration of the first image forming apparatus according to a second modification example of Embodiment 3.

FIG. 25 is a diagram illustrating a change history according to the second modification example of Embodiment 3.

### DESCRIPTION OF EMBODIMENTS

### Embodiment 1

Hereinafter, embodiments will be described with reference to drawings. For clarification of the description, the following description and drawings are omitted and simplified as appropriate. Further, in each drawing, the same reference numerals are assigned to the same elements, and redundant description thereof will be omitted as necessary.

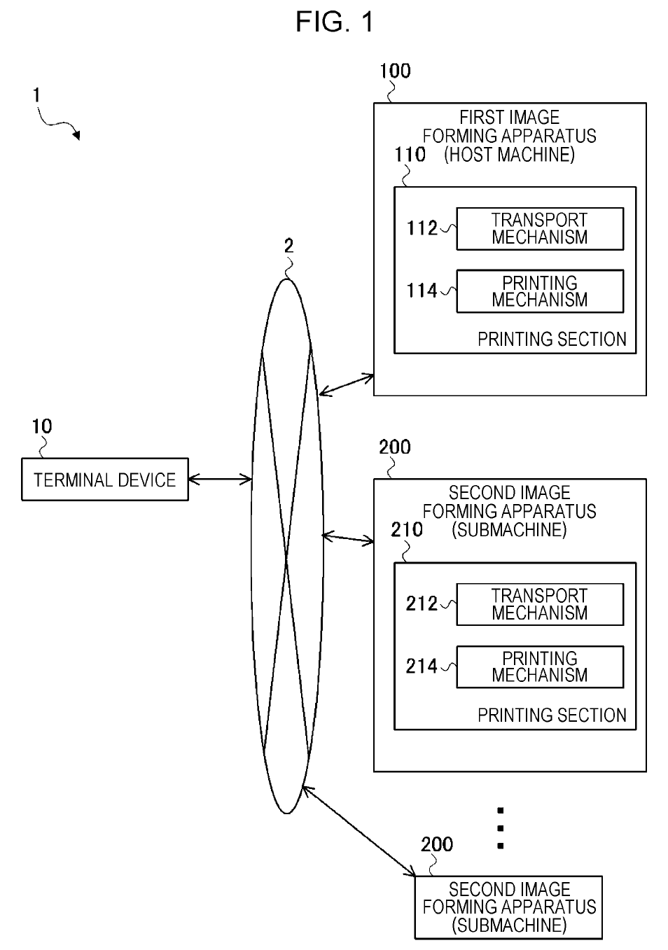

FIG. 1 is a diagram showing a processing system 1 according to Embodiment 1. The processing system 1 includes one or more terminal devices 10, a first image forming apparatus 100, and one or more second image forming apparatuses 200. The terminal device 10, the first image forming apparatus 100, and the second image forming apparatus 200 are communicably coupled to each other, via a wired or wireless network 2. The network 2 may be, for example, a local area network (LAN) such as a wired LAN or a wireless LAN, or the Internet.

The terminal device 10 has a function as a computer including a processor and a memory. The terminal device 10 operates by an OS, which is a basic software. The terminal device 10 is a device used by a user, such as a personal computer (PC), a smartphone, a tablet terminal, or a smart device. The terminal device 10 functions as a client PC. Details of the terminal device 10 will be described below.

The first image forming apparatus 100 is an image forming apparatus such as a printer. Further, the first image forming apparatus 100 may be, for example, a multifunction peripheral (MFP). The first image forming apparatus 100 performs image forming processing, that is, printing processing of forming an image on a print medium such as paper. The first image forming apparatus 100 functions, in the processing system 1, as a host machine.

As shown in FIG. 1, the first image forming apparatus 100 includes a printing section 110. The printing section 110 has a print function for forming an image on paper, that is, a print medium. The printing section 110 includes a print engine. The print engine is a mechanical configuration that performs printing of an image to a print medium. The print engine may have, for example, a mechanism that performs printing with toner by an electrophotographic method. Alternatively, the print engine may have, for example, a mechanism that performs printing by an ink jet method. The printing section 110 forms an image corresponding to a print target in print data on the print medium stored in a paper feed tray, and transports the print medium on which the image is formed to a paper discharge tray.

The printing section 110 has at least a transport mechanism 112 and a printing mechanism 114. The transport mechanism 112 transports a print medium such as paper. The printing mechanism 114 performs an operation for forming an image, which is a print target, on the print medium. Other components of the first image forming apparatus 100 will be described below.

The second image forming apparatus 200 is an image forming apparatus such as a printer. Further, the second image forming apparatus 200 may be, for example, a multifunction peripheral (MFP). The second image forming apparatus 200 performs image forming processing, that is, printing processing of forming an image on a print medium such as paper. The second image forming apparatus 200 functions, in the processing system 1, as a submachine.

As shown in FIG. 1, the second image forming apparatus 200 includes a printing section 210. The printing section 210 has a print function for forming an image on paper, that is, a print medium. The printing section 210 includes a print engine. The print engine is a mechanical configuration that performs printing of an image to a print medium. The print engine may have, for example, a mechanism that performs printing with toner by an electrophotographic method. Alternatively, the print engine may have, for example, a mechanism that performs printing by an ink jet method. The printing section 210 forms an image corresponding to a print target in print data on the print medium stored in the paper feed tray, and transports the print medium on which the image is formed to the paper discharge tray.

The printing section 210 has at least a transport mechanism 212 and a printing mechanism 214. The transport mechanism 212 transports a print medium such as paper. The printing mechanism 214 performs an operation for forming an image, which is a print target, on the print medium. Other components of the second image forming apparatus 200 will be described below.

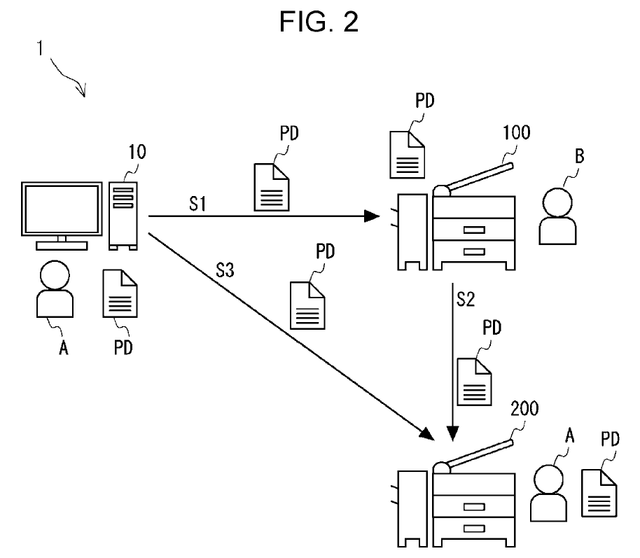

FIG. 2 is a diagram for describing an outline of processing performed in the processing system 1 according to Embodiment 1. The terminal device 10 generates print original document data by an operation of a user A. As indicated by an arrow S1, the terminal device 10 transmits, to the first image forming apparatus 100, print data PD corresponding to the print original document data by the operation of the user A. The print original document data and the print data PD indicate an image that the user A desires to be printed on the print medium. Further, the print data PD transmitted from the terminal device 10 to the first image forming apparatus 100 is generated to correspond to the printing processing in the first image forming apparatus 100. The print data PD will be described below. The first image forming apparatus 100 accumulates the print data PD received from the terminal device 10. The terminal device 10 may accumulate the print data PD transmitted to the first image forming apparatus 100 using, for example, a spooler.

When the first image forming apparatus 100 is used by a user B, the first image forming apparatus 100 cannot immediately print the print data PD. Thus, the user A performs processing such that the print data PD is printed by the second image forming apparatus 200. Specifically, the user A performs an operation to authenticate the user A on the second image forming apparatus 200. Accordingly, the second image forming apparatus 200 performs authentication processing for the user A. When the authentication of the user A is successful, the second image forming apparatus 200 requests the print data PD related to the user A from the first image forming apparatus 100. In this case, the first image forming apparatus 100 transmits a print job list, which is a list of print jobs related to the user A, to the second image forming apparatus 200. Accordingly, an operation panel of the second image forming apparatus 200 displays the print job list related to the user A.

When the user A operates the operation panel on which the print job list is displayed to select the print job related to the print data PD, the second image forming apparatus 200 transmits a selection result to the first image forming apparatus 100. As indicated by an arrow S2, the first image forming apparatus 100 transmits, to the second image forming apparatus 200, the print data PD corresponding to the print job indicated by the selection result. The second image forming apparatus 200 performs the printing processing on the acquired print data PD. Accordingly, the print medium on which the image of the print data PD is formed is discharged to the paper discharge tray.

When the print data PD is accumulated in the terminal device 10, the terminal device 10 may transmit the print data PD to the second image forming apparatus 200. Specifically, when the user A operates the operation panel on which the print job list is displayed to select the print job related to the print data PD, the second image forming apparatus 200 may transmit the selection result to the terminal device 10. As indicated by an arrow S3, the terminal device 10 transmits, to the second image forming apparatus 200, the print data PD corresponding to the print job indicated by the selection result. The second image forming apparatus 200 performs the printing processing on the acquired print data PD. Accordingly, the print medium on which the image of the print data PD is formed is discharged to the paper discharge tray.

The print data PD has a plurality of pieces of band data, which is a unit of printing by a print head included in a printing mechanism of an image forming apparatus that prints the print data PD. That is, the print data PD is configured of the plurality of pieces of band data. The print head has a function of ejecting a liquid such as ink onto a print medium to form an image on the print medium. The band data indicates a part of a print target (print target portion) formed at the print medium when the print head moves relative to the print medium once. That is, when the print head processes one piece of band data, the print target portion corresponding to the band data is formed at the print medium. The band data has a predetermined direction in the print target as a longitudinal direction. Hereinafter, details will be described.

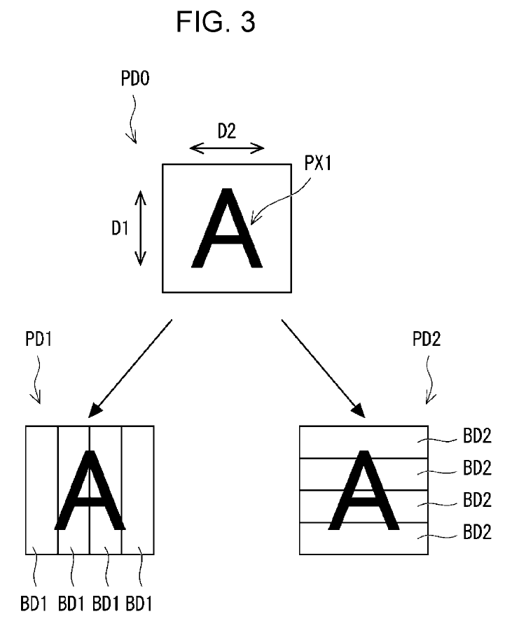

FIG. 3 is a diagram illustrating the print original document data and the print data according to Embodiment 1. Print original document data PD0 is generated by an application such as a document editing software or an image editing software. The print original document data may be, for example, a portable document format (PDF) data. The print original document data PD0 indicates a print target PX1. In the example of FIG. 3, the print target PX1 in the print original document data PD0 indicates a character "A". The print original document data PD0 may be bitmap data obtained by rendering the print target PX1. In the example of FIG. 3, a vertical direction of the print target is set as a first direction D1, and a horizontal direction of the print target is set as a second direction D2. That is, the second direction is a direction that intersects with the first direction. The "intersecting direction" is, for example, an orthogonal direction, but does not need to be strictly orthogonal. That is, the second direction does not need to be orthogonal to the first direction.

Based on the print original document data PD0, print data PD1 and print data PD2 are generated. The print data PD1 and the print data PD2 are generated according to a function of the image forming apparatus that prints the image of the print original document data PD0. For example, the print data PD1 and the print data PD2 are generated by a printer driver corresponding to the image forming apparatus that prints the image of the print original document data PD0. Each of the print data PD1 and the print data PD2 includes the plurality of pieces of band data.

The print data PD1 includes a plurality of pieces of first band data BD1, which are pieces of band data divided with the first direction D1, which is the vertical direction of the print target PX1, as the longitudinal direction. That is, the print data PD1 is configured as a bundle of the plurality of pieces of first band data BD1. In the print data PD1, the plurality of pieces of first band data BD1 are disposed side by side along the second direction D2, which is the horizontal direction of the print target PX1. That is, in the print data PD1, the first band data BD1 is generated to divide the print target PX1 in the second direction D2. A band width (number of pixels) of the first band data BD1, which is a width in the second direction D2, corresponds to a length of the print head in the second direction D2.

The print data PD2 includes a plurality of pieces of second band data BD2, which are pieces of band data divided with the second direction D2, which is the horizontal direction of the print target PX1, as the longitudinal direction. That is, the print data PD2 is configured as a bundle of the plurality of pieces of second band data BD2. In the print data PD2, the plurality of pieces of second band data BD2 are disposed side by side along the first direction D1, which is the vertical direction of the print target PX1. That is, in the print data PD2, the second band data BD2 is generated to divide the print target PX1 in the first direction D1. A band width (number of pixels) of the second band data BD2, which is a width in the first direction D1, corresponds to a length of the print head in the first direction D1.

In the example of FIG. 3, the vertical direction of the print target PX1 is conveniently set as the first direction D1, and the horizontal direction of the print target PX1 is conveniently set as the second direction D2, but the present embodiment is not limited to such a configuration. The first direction and the second direction may be opposite to those in the example in FIG. 3, respectively. That is, the horizontal direction of the print target PX1 may be the first direction, and the vertical direction of the print target PX1 may be the second direction. In this case, the first band data is band data with the horizontal direction of the print target PX1 as the longitudinal direction. The second band data is band data with the vertical direction of the print target PX1 as the longitudinal direction. Hereinafter, a case of the first band data and the second band data in the example of FIG. 3 will be described. That is, hereinafter, an example will be described in which the first band data BD1 is band data with the first direction D1, which is the vertical direction of the print target PX1, as the longitudinal direction, and the second band data BD2 is band data with the second direction D2, which is the horizontal direction of the print target PX1, as the longitudinal direction.

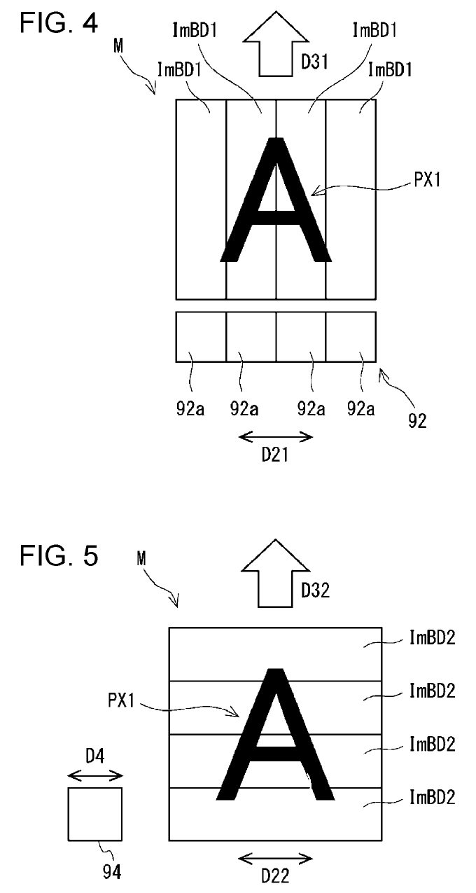

FIG. 4 is a diagram showing an example in which the image forming apparatus according to Embodiment 1 processes the first band data BD1 to form an image on a print medium. The image forming apparatus according to FIG. 4 corresponds to the first image forming apparatus 100 and the second image forming apparatus 200 described above. That is, the first image forming apparatus 100 may perform processing shown in FIG. 4. Further, the second image forming apparatus 200 may perform the processing shown in FIG. 4.

In the example of FIG. 4, the transport mechanism corresponding to the transport mechanism 112 and the transport mechanism 212 transports a print medium M in a transport direction D31. Further, the printing mechanism corresponding to the printing mechanism 114 and the printing mechanism 214 has a long print head unit 92 extending in a direction D21 intersecting the transport direction D31 of the print medium M. The print head unit 92 is fixed in the image forming apparatus. The print head unit 92 has a plurality of print heads 92a disposed along the direction D21. Each of the plurality of print heads 92a has a plurality of nozzles that can eject a liquid such as ink. The plurality of print heads 92a disposed side by side along the direction D21 can execute the printing over the entire width direction (direction along the direction D21) of the print medium M transported along the direction D31. The print head unit 92 may also be referred to as a line-type print head.

While the transport mechanism transports the print medium M in the transport direction D31, each of the plurality of print heads 92a processes each of the plurality of pieces of first band data BD1 in the print data PD1. Accordingly, each of the plurality of print heads 92a forms, at the print medium M, a first print target portion ImBD1 corresponding to the first band data BD1. That is, each of the plurality of print heads 92a moves once with respect to the print medium M to form, at the print medium M, the first print target portion ImBD1 corresponding to the first band data BD1. Accordingly, the image forming apparatus forms the print target PX1 at the entire print medium M.

FIG. 5 is a diagram showing an example in which the image forming apparatus according to Embodiment 1 processes the second band data BD2 to form an image on a print medium. The image forming apparatus according to FIG. 5 corresponds to the first image forming apparatus 100 and the second image forming apparatus 200 described above. That is, the first image forming apparatus 100 may perform processing shown in FIG. 5. Further, the second image forming apparatus 200 may perform the processing shown in FIG. 5.

In the example of FIG. 5, the transport mechanism corresponding to the transport mechanism 112 and the transport mechanism 212 transports the print medium M in a transport direction D32. Further, the printing mechanism corresponding to the printing mechanism 114 and the printing mechanism 214 has a print head 94. As indicated by an arrow D4, the print head 94 can reciprocate along a direction D22 intersecting the transport direction D32 of the print medium M. The print head 94 has a plurality of nozzles that can eject a liquid such as ink. The print head 94 can execute the printing over the entire width direction (direction along the direction D22) of the print medium M by moving (scanning) in the direction D22. The print head 94 may also be referred to as a serial-type print head.

The operation of the transport mechanism transporting the print medium M in the transport direction D32 and the operation of the print head 94 moving along the direction D22 are alternately executed. In this case, the print head 94 processes each of the plurality of pieces of second band data BD2 in the print data PD2 each time the print head 94 moves once to form, at the print medium M, a second print target portion ImBD2 corresponding to the second band data BD2. The image forming apparatus repeatedly performs the alternate execution of the operation of transporting the print medium M in the transport direction D32 and the operation of the print head 94 moving along the direction D22 to form the print target PX1 on the entire print medium M.

The printing section 110 of the first image forming apparatus 100 may have any one of the print head unit 92 and the print head 94. That is, the first image forming apparatus 100 may be able to process any one of the first band data BD1 and the second band data BD2. Similarly, the printing section 210 of the second image forming apparatus 200 may have any one of the print head unit 92 and the print head 94. That is, the second image forming apparatus 200 may be able to process any one of the first band data BD1 and the second band data BD2. Further, the printing section 110 of the first image forming apparatus 100 may have both the print head unit 92 and the print head 94. That is, the first image forming apparatus 100 may be able to process both the first band data BD1 and the second band data BD2. Similarly, the printing section 210 of the second image forming apparatus 200 may have both the print head unit 92 and the print head 94. That is, the second image forming apparatus 200 may be able to process both the first band data BD1 and the second band data BD2.

Further, in the example of FIG. 4, the first band data BD1 is assumed to be processed by the print head unit 92, but the first band data BD1 may be processed by the print head 94 shown in FIG. 5. Similarly, in the example of FIG. 5, the second band data BD2 is assumed to be processed by the print head 94, but the second band data BD2 may be processed by the print head unit 92. That is, in the examples of FIGS. 4 and 5, the first direction D1 (vertical direction) of the print target PX1 formed at the print medium M is along the transport direction of the print medium M. On the other hand, the image forming apparatus may form the print target PX1 at the print medium M such that the second direction D2 (horizontal direction) of the print target PX1 is along the transport direction of the print medium M. In this case, the print head 94 shown in FIG. 5 may process each of the first band data BD1 of the print data PD1 to form the first print target portion ImBD1 at the print medium M. Similarly, each of the print heads 92a of the print head unit 92 shown in FIG. 4 may process each of the second band data BD2 of the print data PD2 to form the second print target portion ImBD2 at the print medium M.

Which piece of band data of the first band data BD1 and the second band data BD2 can be processed by the first image forming apparatus 100 may be determined by, for example, a model of the first image forming apparatus 100. Similarly, which piece of band data of the first band data BD1 and the second band data BD2 can be processed by the second image forming apparatus 200 may be determined by, for example, a model of the second image forming apparatus 200. Further, the first image forming apparatus 100 may process any one of the first band data BD1 and the second band data BD2 according to a print setting for the first image forming apparatus 100. Similarly, the second image forming apparatus 200 may process any one of the first band data BD1 and the second band data BD2 according to a print setting for the second image forming apparatus 200.

Further, the image forming apparatus such as the first image forming apparatus 100 and the second image forming apparatus 200 may have a change function of changing the longitudinal direction of the band data in the print data acquired from the terminal device 10 or the other image forming apparatus. For example, when the image forming apparatus can process any one of the first band data BD1 and the second band data BD2 and the acquired print data is configured to include the band data that cannot be processed, the longitudinal direction of the band data in the print data may be changed by using the change function. Further, for example, in the print setting related to the acquired print data, when the band data constituting the print data cannot be processed, the image forming apparatus may use the change function to change the longitudinal direction of the band data in the print data.

For example, the image forming apparatus A is assumed to be unable to process the first band data BD1 but able to process the second band data BD2. The image forming apparatus A is assumed to have the change function. In this case, when the print data PD1 configured of the first band data BD1 is acquired, the image forming apparatus A may use the change function to change the longitudinal direction of the band data in the print data PD1. That is, the image forming apparatus A may change the longitudinal direction of the band data in the print data PD1 from the first direction D1 to the second direction D2. Accordingly, the image forming apparatus A may convert the print data PD1, which is configured of the first band data BD1 with the first direction D1 as the longitudinal direction, into the print data PD2, which is configured of the second band data BD2 with the second direction D2 as the longitudinal direction. The image forming apparatus A may use the print data PD2 configured of the second band data BD2 to perform the printing.

Further, for example, an image forming apparatus B is assumed to be unable to process the second band data BD2 but able to process the first band data BD1. The image forming apparatus B is assumed to have the change function. In this case, when the print data PD2 configured of the second band data BD2 is acquired, the image forming apparatus B may use the change function to change the longitudinal direction of the band data in the print data PD2. That is, the image forming apparatus B may change the longitudinal direction of the band data in the print data PD2 from the second direction D2 to the first direction D1. Accordingly, the image forming apparatus B may convert the print data PD2, which is configured of the second band data BD2 with the second direction D2 as the longitudinal direction, into the print data PD1, which is configured of the first band data BD1 with the first direction D1 as the longitudinal direction. The image forming apparatus B may use the print data PD1 configured of the first band data BD1 to perform the printing.

Further, for example, an image forming apparatus C is assumed to be able to process both the first band data BD1 and the second band data BD2, but be unable to process the first band data BD1 in a certain print setting C1. Further, the image forming apparatus C is assumed to have the change function. The image forming apparatus C is assumed to acquire the print data PD1, which is configured of the first band data BD1 and instructed to be printed with the print setting C1. In this case, the image forming apparatus C may use the change function to change the longitudinal direction of the band data in the print data PD1 as described above. The image forming apparatus C may use, in the print setting C1, the print data PD2 configured of the second band data BD2 to perform the printing.

Further, for example, an image forming apparatus D is assumed to be able to process both the first band data BD1 and the second band data BD2, but be unable to process the second band data BD2 in a certain print setting D1. Further, the image forming apparatus D is assumed to have the change function. The image forming apparatus D is assumed to acquire the print data PD2, which is configured of the second band data BD2 and instructed to be printed with the print setting D1. In this case, the image forming apparatus D may use the change function to change the longitudinal direction of the band data in the print data PD2 as described above. The image forming apparatus D may use, in the print setting D1, the print data PD1 configured of the first band data BD1 to perform the printing.

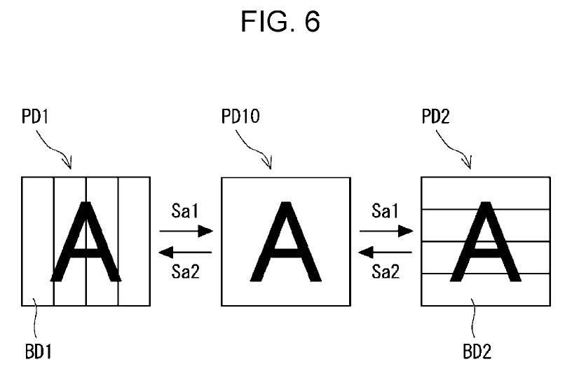

FIG. 6 is a diagram for describing the change function according to Embodiment 1. In FIG. 6, an arrow Sa1 indicates a flow in which the longitudinal direction of the first band data BD1 is changed by using the change function. With the change function, the print data PD1, which is configured of the plurality of pieces of first band data BD1 with the first direction D1 as the longitudinal direction, is acquired. With the change function, the plurality of pieces of first band data BD1 are combined to generate print data PD10 corresponding to the print original document data PD0. With the change function, the print data PD10 is divided into the plurality of pieces of second band data BD2 with the second direction D2 as the longitudinal direction to generate the print data PD2. In this manner, with the change function, the longitudinal direction of the band data in the print data is changed from the first direction D1 to the second direction D2, and thus the print data PD1 is converted into the print data PD2.

Further, in FIG. 6, an arrow Sa2 indicates a flow in which the longitudinal direction of the second band data BD2 is changed by using the change function. With the change function, the print data PD2, which is configured of the plurality of pieces of second band data BD2 with the second direction D2 as the longitudinal direction, is acquired. With the change function, the plurality of pieces of second band data BD2 are combined to generate print data PD10 corresponding to the print original document data PD0. With the change function, the print data PD10 is divided into the plurality of pieces of first band data BD1 with the first direction D1 as the longitudinal direction to generate the print data PD1. In this manner, with the change function, the longitudinal direction of the band data in the print data is changed from the second direction D2 to the first direction D1, and thus the print data PD2 is converted into the print data PD1.

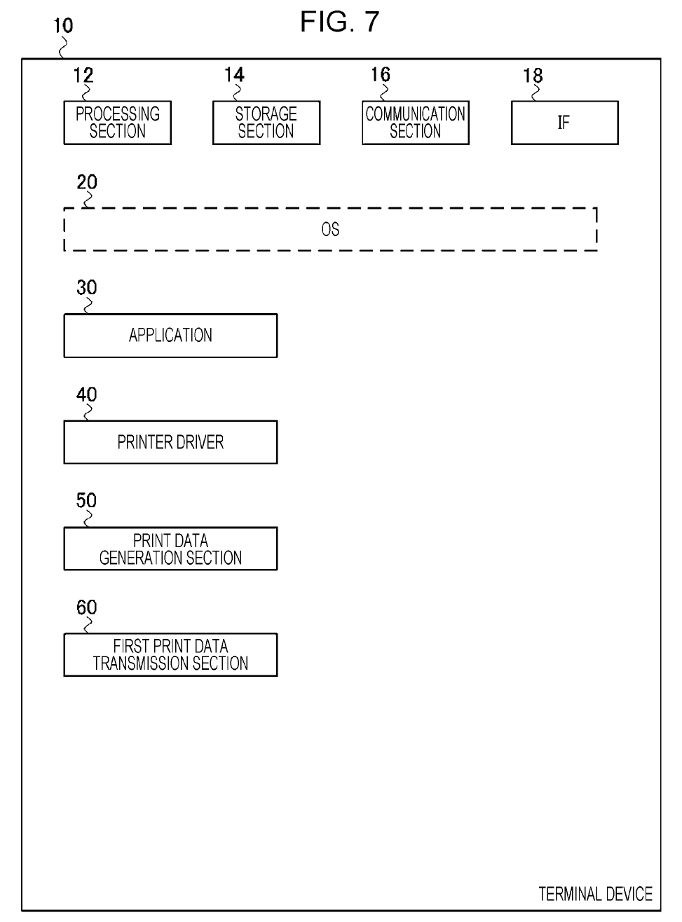

FIG. 7 is a diagram showing a configuration of the terminal device 10 according to Embodiment 1. The terminal device 10 includes a processing section 12, a storage section 14, a communication section 16, and an interface section 18, as a main hardware configuration. The processing section 12, the storage section 14, the communication section 16, and the interface section 18 may be coupled to each other, via a data bus or the like.

The processing section 12 is a processor such as a central processing unit (CPU). The processing section 12 may have a plurality of processors. The processing section 12 has a function as a calculation device that performs control processing, calculation processing, and the like. The processing section 12 controls the storage section 14, the communication section 16, and the interface section 18.

The storage section 14 is a storage device such as a memory or a hard disk. The storage section 14 is, for example, a read only memory (ROM) or a random access memory (RAM). The storage section 14 has a function of storing a control program, a calculation program, and the like, which are executed by the processing section 12. Further, the storage section 14 has a function of temporarily storing processing data and the like. The storage section 14 may include a database.

The communication section 16 performs processing necessary for the terminal device 10 to perform communication with another device, via the network 2. The communication section 16 may include a communication port, a router, a firewall, and the like. The communication section 16 performs processing for the terminal device 10 to perform communication with the first image forming apparatus 100 and the second image forming apparatus 200. The communication section 16 may perform processing for the terminal device 10 to perform communication with the first image forming apparatus 100 and the second image forming apparatus 200, via a LAN such as a wireless LAN. Further, the communication section 16 may perform processing for the terminal device 10 to perform communication with the first image forming apparatus 100 and the second image forming apparatus 200, via the Internet.

The interface section 18 is, for example, a user interface. The interface section 18 receives an operation to input data by the user of the terminal device 10, and outputs information to the user. The interface section 18 has a display portion and an operation portion. The display portion is a display device, such as a display, that displays an image. The display portion is an output device that outputs information. The operation portion is an input device, such as a keyboard or a mouse, for inputting or selecting information. The operation portion is an input device that inputs information. The interface section 18 may be configured such that an input device and an output device are integrated, such as a touch screen or a touch panel. In this case, the display portion and the operation portion may be physically integrated. Further, the interface section 18 may have a speaker and a microphone.

Further, the terminal device 10 according to Embodiment 1 includes an operating system (OS) 20, an application 30, a printer driver 40, a print data generation section 50, and a first print data transmission section 60, as components. The OS 20 is basic software. Further, each component other than the OS 20 operates using a function of the OS 20.

Each component described above can be realized by, for example, execution of a program under the control of the processing section 12. More specifically, each component can be realized by the processing section 12 executing a program stored in the storage section 14. Further, a necessary program may be recorded on any non-volatile recording medium and installed as necessary to realize each component. This is the same in other embodiments.

Further, each component may be realized by any combination of hardware, firmware, and software, without being limited to being realized by software according to a program. Further, each component may be realized by using an integrated circuit, which is programmable by the user, such as a field-programmable gate array (FPGA) or a microcomputer. In this case, a program configured to include each component described above may be realized by using the integrated circuit. This is the same in other embodiments.

The application 30 is application software that can perform processing accompanied by printing. The application 30 may be, for example, the document editing software, spreadsheet software, the image editing software, or photo display software. The application 30 generates the print original document data.

The printer driver 40 is installed in the terminal device 10 by an operation of an installer. The printer driver 40 is software for controlling the image forming apparatus such as the first image forming apparatus 100 and the second image forming apparatus 200 to operate the image forming apparatus. The printer driver 40 generates the print job corresponding to the print original document data generated by the application 30. The printer driver 40 is provided for at least the first image forming apparatus 100. When the user performs an operation of causing the first image forming apparatus 100 to perform the printing processing of the print original document data, the printer driver 40 of the first image forming apparatus 100 generates the print job corresponding to the print setting of the first image forming apparatus 100 by using the print original document data. The printer driver 40 may be provided for the second image forming apparatus 200. In this case, when the user performs an operation of causing the second image forming apparatus 200 to perform the printing processing of the print original document data, the printer driver 40 of the second image forming apparatus 200 generates the print job corresponding to the print setting of the second image forming apparatus 200 by using the print original document data.

The print data generation section 50 generates the print data that is the print target in the first image forming apparatus 100, the print data being transmitted to the host machine, that is, the first image forming apparatus 100. The print data generation section 50 may be realized by the printer driver 40. The print data generation section 50 acquires the print original document data generated by the application 30. The print data generation section 50 generates the print data used in the first image forming apparatus 100 by using the print original document data.

The print data generation section 50 generates the print data in accordance with the function of the first image forming apparatus 100. Specifically, the print data generation section 50 generates the print data configured of the band data that can be processed according to the function of the first image forming apparatus 100. More specifically, when the first image forming apparatus 100 can process the first band data BD1 and cannot process the second band data BD2, the print data generation section 50 generates the print data PD1 configured of the first band data BD1. Further, when the first image forming apparatus 100 can process the second band data BD2 and cannot process the first band data BD1, the print data generation section 50 generates the print data PD2 configured of the second band data BD2.

Further, when the first image forming apparatus 100 can process both the first band data BD1 and the second band data BD2, the print data generation section 50 may generate any one of the print data PD1 and the print data PD2, in accordance with the print setting designated by the user. For example, the print data generation section 50 may generate any one of the print data PD1 and the print data PD2, in accordance with a paper size designated by the user. For example, the first image forming apparatus 100 processes the second band data BD2 when the printing is performed on A4 size paper, and processes the first band data BD1 when the printing is performed on A3 size paper. In this example, when the user designates the paper size as "A4 size", the print data generation section 50 generates the print data PD2 configured of the second band data BD2. Further, when the user designates the paper size as "A3 size", the print data generation section 50 generates the print data PD1 configured of the first band data BD1.

The first print data transmission section 60 performs processing of transmitting, to the first image forming apparatus 100, the print data generated by the print data generation section 50. The first print data transmission section 60 may control the communication section 16 to transmit the print data to the first image forming apparatus 100. The first print data transmission section 60 may transmit the print job including the print data to the first image forming apparatus 100, as a print command for the first image forming apparatus 100. The print job (print command) may include the print data, print settings, user identification information which is identification information of the user of the terminal device 10, and a transmission point in time of the print job (print data). The user identification information may be identification information of the terminal device 10.

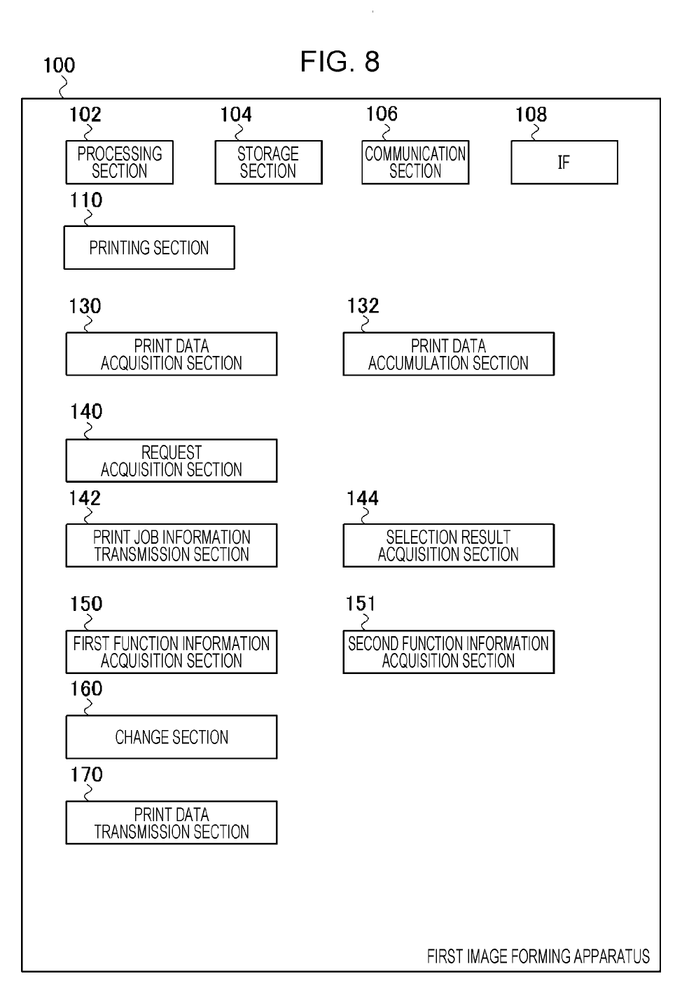

FIG. 8 is a diagram showing a configuration of the first image forming apparatus 100 according to Embodiment 1. The first image forming apparatus 100 includes a processing section 102, a storage section 104, a communication section 106, an interface section 108, and a printing section 110, as a main hardware configuration. The processing section 102, the storage section 104, the communication section 106, the interface section 108, and the printing section 110 may be coupled to each other, via a data bus or the like.

The processing section 102 is a processor such as a CPU. The processing section 102 may have a plurality of processors. The processing section 102 has a function as a calculation device that performs control processing, calculation processing, and the like. The processing section 102 controls the storage section 104, the communication section 106, the interface section 108, and the printing section 110.

The storage section 104 is a storage device such as a memory or a hard disk. The storage section 104 is, for example, a ROM or a RAM. The storage section 104 has a function of storing a control program, a calculation program, and the like, which are executed by the processing section 102. Further, the storage section 104 has a function of temporarily storing processing data and the like. The storage section 104 may include a database.

The communication section 106 performs processing necessary for the first image forming apparatus 100 to perform communication with another device, via the network 2. The communication section 106 may include a communication port, a router, a firewall, and the like. The communication section 106 performs processing for the first image forming apparatus 100 to perform communication with the terminal device 10 and the second image forming apparatus 200. The communication section 106 may perform processing for the first image forming apparatus 100 to perform communication with the terminal device 10 and the second image forming apparatus 200, via a LAN such as a wireless LAN. Further, the communication section 106 may perform processing for the first image forming apparatus 100 to perform communication with the terminal device 10 and the second image forming apparatus 200, via the Internet.

The interface section 108 is, for example, a user interface. The interface section 108 receives an operation to input data by the user of the first image forming apparatus 100, and outputs information to the user. The interface section 108 includes an input device such as a button, a keyboard, a touch panel, or a mouse, and an output device such as a display or a speaker. The interface section 108 may be configured to include the input device and the output device integrally. The interface section 108 receives an operation to input data by the user, and outputs information to the user. The interface section 108 includes the operation panel.

Further, the first image forming apparatus 100 includes a print data acquisition section 130 and a print data accumulation section 132, as components. Further, the first image forming apparatus 100 includes a request acquisition section 140, a print job information transmission section 142, a selection result acquisition section 144, a first function information acquisition section 150, a second function information acquisition section 151, a change section 160, and a print data transmission section 170, as components. The first image forming apparatus 100 may have an OS as basic software. Each component described above other than the OS may operate using a function of the OS. Further, the first image forming apparatus 100 may have substantially the same components as the components of the second image forming apparatus 200 described below, as components. That is, the first image forming apparatus 100 may function as the submachine. This is the same in other embodiments described below.

Each component described above can be realized by, for example, execution of a program under the control of the processing section 102. More specifically, each component may be realized by the processing section 102 executing a program stored in the storage section 104. Further, a necessary program may be recorded on any non-volatile recording medium and installed as necessary to realize each component. These matters are the same in other embodiments.

Further, each component may be realized by any combination of hardware, firmware, and software, without being limited to being realized by software according to a program. Further, each component may be realized by using an integrated circuit, which is programmable by the user, such as an FPGA or a microcomputer. In this case, a program configured to include each component described above may be realized by using the integrated circuit. These matters are the same in other embodiments.

The print data acquisition section 130 acquires the print data from the terminal device 10. Specifically, the print data acquisition section 130 acquires the print data indicating the print target in the first image forming apparatus 100. The print data acquisition section 130 may acquire the print data with reception of the print data from the terminal device 10 by the communication section 106. Further, the print data acquisition section 130 may acquire the print data with acquisition of the print job from the terminal device 10.

The print data acquisition section 130 acquires the print data including any one of the band data divided with the first direction D1 of the print target as the longitudinal direction and the band data divided with the second direction D2 of the print target as the longitudinal direction. In other words, the print data acquisition section 130 acquires the print data including any one of the first band data BD1 and the second band data BD2. In other words, the print data acquisition section 130 acquires the print data configured of any one of the first band data BD1 and the second band data BD2.

Further, the print data acquisition section 130 may acquire the print data configured of the band data that can be processed according to the function of the first image forming apparatus 100. Thus, when the first image forming apparatus 100 processes the first band data BD1 with a function according to the designated print setting, the print data acquisition section 130 acquires the print data PD1 configured of the first band data BD1. Further, when the first image forming apparatus 100 processes the second band data BD2 with a function according to the designated print setting, the print data acquisition section 130 acquires the print data PD2 configured of the second band data BD2.

The print data accumulation section 132 accumulates the acquired print data. The print data accumulation section 132 may be realized by the storage section 104. The print data accumulation section 132 accumulates the print data in association with the user identification information of the user of the terminal device 10 that transmits the print data. In other words, the print data accumulation section 132 accumulates the print job including the print data and the user identification information. Accordingly, the print data accumulation section 132 stores print job information indicating a plurality of print jobs. The print job information indicates the print job list, which is a list of print jobs. The print job information may be generated for each user.

The request acquisition section 140 acquires, from the second image forming apparatus 200, a print data request for requesting transmission of the print data. In other words, the request acquisition section 140 acquires, from the second image forming apparatus 200, the request for the print data acquired by the first image forming apparatus 100. The request acquisition section 140 may acquire the print data request with reception of the print data request from the second image forming apparatus 200 by the communication section 106. Specifically, when the authentication processing is performed in the second image forming apparatus 200 and the user authentication is successful, the request acquisition section 140 acquires the print data request from the second image forming apparatus 200. The authentication processing in the second image forming apparatus 200 will be described below.

The print data request may include the user identification information, which is the identification information of the user who is successfully authenticated, and submachine identification information, which is the identification information of the second image forming apparatus 200. Further, the print data request may include first function information and second function information of the second image forming apparatus 200.

The first function information indicates whether or not the second image forming apparatus 200 can change the longitudinal direction of the band data in the print data. That is, the first function information indicates whether or not the second image forming apparatus 200 has the change function described above with reference to FIG. 6. In other words, a first function related to the first function information corresponds to the change function. When the second image forming apparatus 200 has the change function, the first function information indicates that the second image forming apparatus 200 can change the longitudinal direction of the band data in the print data, that is, indicates "with change function". When the second image forming apparatus 200 does not have the change function, the first function information indicates that the second image forming apparatus 200 cannot change the longitudinal direction of the band data in the print data, that is, "without change function".

Further, the second function information indicates which of the first band data BD1 and the second band data BD2 is to be processed by the second image forming apparatus 200. That is, the second function information indicates the longitudinal direction of the band data processed by the second image forming apparatus 200. In other words, the second function related to the second function information is in relation to which band data can be processed by the second image forming apparatus 200.

For example, when the second image forming apparatus 200 processes the first band data BD1, the second function information indicates that the second image forming apparatus 200 processes the band data with the first direction D1 of the print target as the longitudinal direction. That is, the second function information indicates that the longitudinal direction of the band data processed by the second image forming apparatus 200 is "first direction D1". In other words, the second function information indicates "first band data BD1".

Further, when the second image forming apparatus 200 processes the second band data BD2, the second function information indicates that the second image forming apparatus 200 processes the band data with the second direction D2 of the print target as the longitudinal direction. That is, the second function information indicates that the longitudinal direction of the band data processed by the second image forming apparatus 200 is "second direction D2". In other words, the second function information indicates "second band data BD2".

Further, when the second image forming apparatus 200 processes the first band data BD1 and the second band data BD2, the second function information indicates that the second image forming apparatus 200 processes the band data with the first direction D1 of the print target as the longitudinal direction and the band data with the second direction D2 of the print target as the longitudinal direction. That is, the second function information indicates that the longitudinal direction of the band data processed by the second image forming apparatus 200 is "first direction D1" and "second direction D2". In other words, the second function information indicates "first band data BD1" and "second band data BD2".

Further, the second function information may indicate which of the first band data BD1 and the second band data BD2 is to be processed by the second image forming apparatus 200 for each print setting. For example, it is assumed that the second image forming apparatus 200 processes the first band data BD1 in a print setting A and processes the second band data BD2 in a print setting B. In this case, the second function information may indicate "print setting A: first band data BD1" and "print setting B: second band data BD2". That is, the second function information may indicate "print setting A: longitudinal direction of band data is first direction D1" and "print setting B: longitudinal direction of band data is second direction D2".

With the acquisition of the print data request from the second image forming apparatus 200 by the request acquisition section 140, the second image forming apparatus 200 that requests the print data can be specified. Further, when the authentication of the user is successful in the second image forming apparatus 200, with the acquisition of the print data request from the second image forming apparatus 200 by the request acquisition section 140, the second image forming apparatus 200 that requests the print data and the user can be specified.

The print job information transmission section 142 performs processing of transmitting the print job information to the second image forming apparatus 200. The print job information transmission section 142 may control the communication section 106 to transmit the print job information to the second image forming apparatus 200. The print job information transmission section 142 transmits the print job information related to the user identification information indicated in the print data request, which is accumulated in the print data accumulation section 132, to the second image forming apparatus 200 related to the submachine identification information indicated in the print data request. That is, the print job information transmission section 142 transmits, to the second image forming apparatus 200, the print job information related to the user who is successfully authenticated.

Accordingly, the operation panel of the second image forming apparatus 200 displays the print job list related to the user who is successfully authenticated. As described above, when the user operates the operation panel to select the print job, the second image forming apparatus 200 transmits the selection result of the print job to the first image forming apparatus 100.

The selection result acquisition section 144 acquires the selection result of the print job from the second image forming apparatus 200. The selection result acquisition section 144 may acquire the selection result with reception of the selection result from the second image forming apparatus 200 by the communication section 106. The selection result indicates the print job selected by the user. Further, the selection result may include the first function information and the second function information of the second image forming apparatus 200. Further, the selection result may indicate a request for the print data related to the print job selected by the user. In this case, the selection result acquisition section 144 may function as a request acquisition section that acquires, from the second image forming apparatus, the request for the print data acquired by the first image forming apparatus 100.

The first function information acquisition section 150 acquires the first function information related to the second image forming apparatus 200. The first function information acquisition section 150 acquires the first function information of the second image forming apparatus 200 that transmits the print data request. When the print data request includes the first function information, the first function information acquisition section 150 may acquire the first function information from the print data request. When the selection result includes the first function information, the first function information acquisition section 150 may acquire the first function information from the selection result. Further, the first function information acquisition section 150 may acquire the first function information from the second image forming apparatus 200, separately from the print data request and the selection result. In this case, the first function information acquisition section 150 may acquire the first function information from the second image forming apparatus 200, in response to the acquisition of the request for the print data.

The second function information acquisition section 151 acquires second function information related to the second image forming apparatus 200. The second function information acquisition section 151 acquires the second function information of the second image forming apparatus 200 that transmits the print data request. When the print data request includes the second function information, the second function information acquisition section 151 may acquire the second function information from the print data request. When the selection result includes the second function information, the second function information acquisition section 151 may acquire the second function information from the selection result. Further, the second function information acquisition section 151 may acquire the second function information from the second image forming apparatus 200, separately from the print data request and the selection result. In this case, the second function information acquisition section 151 may acquire the second function information from the second image forming apparatus 200, in response to the acquisition of the request for the print data.

The change section 160 performs the change processing of the longitudinal direction of the band data in the acquired print data. In other words, the change section 160 performs the change processing of the longitudinal direction of the band data in the print data, which corresponds to the print job indicated in the selection result. The change section 160 performs the change processing on the print data stored in the print data accumulation section 132. Specifically, the change section 160 performs the change processing of the longitudinal direction of the band data in the print data, based on the first function information. Further, the change section 160 performs the change processing of the longitudinal direction of the band data in the print data, based on the second function information. That is, the change section 160 compares the longitudinal direction of the band data in the print data with the longitudinal direction of the band data indicated by the second function information. The change section 160 performs the change processing of the longitudinal direction of the band data in the print data, based on a result of the comparison.

More specifically, when the first function information indicates "with change function", that is, when the second image forming apparatus 200 can change the longitudinal direction of the band data in the print data, the change section 160 decides not to change the longitudinal direction of the band data in the print data. Further, when the longitudinal direction of the band data in the print data matches the longitudinal direction of the band data indicated by the second function information, the change section 160 decides not to change the longitudinal direction of the band data in the print data.

On the other hand, when the second image forming apparatus 200 cannot change the longitudinal direction of the band data in the print data, and when the longitudinal direction of the band data in the print data does not match the longitudinal direction of the band data indicated by the second function information, the change section 160 changes the longitudinal direction of the band data in the print data. In other words, when the first function information indicates "without change function" and the longitudinal direction of the band data in the print data does not match the longitudinal direction of the band data indicated by the second function information, the change section 160 changes the longitudinal direction of the band data in the print data. As described above, the change processing by the change section 160 includes the case where the longitudinal direction of the band data in the print data is changed and the case where the longitudinal direction of the band data in the print data is not changed.

As described above, the first image forming apparatus 100 acquires the first function information and the second function information, in response to the acquisition of the request for the print data from the second image forming apparatus 200. The change section 160 performs the change processing of the longitudinal direction of the band data in the print data, based on the first function information and the second function information. Thus, the change section 160 determines whether or not to change the longitudinal direction of the band data in the print data, in response to the acquisition of the request for the print data.

Here, a case will be described in which the first function information indicates "without change function", that is, the second image forming apparatus 200 cannot change the longitudinal direction of the band data in the print data. In this case, it is assumed that the print data is the print data PD1 including the first band data BD1 and the second function information indicates "second band data BD2". In this case, the longitudinal direction of the band data in the print data does not match the longitudinal direction of the band data indicated by the second function information. Thus, the change section 160 changes the longitudinal direction of the first band data BD1, as indicated by an arrow Sa1 in FIG. 6. That is, the change section 160 combines the plurality of pieces of the first band data BD1 to generate the print data PD10, and divides the print data PD10 into the plurality of pieces of the second band data BD2 with the second direction D2 as the longitudinal direction to generate the print data PD2. In this manner, the change section 160 changes the longitudinal direction of the band data in the print data from the first direction D1 to the second direction D2, and thus converts the print data PD1 into the print data PD2.

Further, in the above case, it is assumed that the print data is the print data PD2 including the second band data BD2 and the second function information indicates the "first band data BD1". In this case, the longitudinal direction of the band data in the print data does not match the longitudinal direction of the band data indicated by the second function information. Thus, the change section 160 changes the longitudinal direction of the second band data BD2, as indicated by an arrow Sa2 in FIG. 6. That is, the change section 160 combines the plurality of pieces of second band data BD2 to generate the print data PD10, and divides the print data PD10 into the plurality of pieces of first band data BD1 with the first direction D1 as the longitudinal direction to generate the print data PD1. In this manner, the change section 160 changes the longitudinal direction of the band data in the print data from the second direction D2 to the first direction D1, and thus converts the print data PD2 into the print data PD1.

In the above case, it is assumed that the print data is print data PD1 including the first band data BD1 and the second function information indicates the first band data BD1. In this case, the longitudinal direction of the band data in the print data matches the longitudinal direction of the band data indicated by the second function information. Thus, the change section 160 decides not to change the longitudinal direction of the first band data BD1. Further, in the above case, it is assumed that the print data is print data PD2 including the second band data BD2 and the second function information indicates the second band data BD2. In this case, the longitudinal direction of the band data in the print data matches the longitudinal direction of the band data indicated by the second function information. Thus, the change section 160 decides not to change the longitudinal direction of the second band data BD2.

Further, as described above, the second function information may indicate which of the first band data BD1 and the second band data BD2 is to be processed by the second image forming apparatus 200 for each print setting. In this case, the change section 160 may perform the change processing of the longitudinal direction of the band data in the print data, based on the result of the comparison between the longitudinal direction of the band data in the print data and the longitudinal direction of the band data, which is indicated by the second function information, in the print setting related to the print data. In this case, for example, it is assumed that the second function information indicates "print setting A: first band data BD1" and "print setting B: second band data BD2". In this case, it is assumed that the print data is the print data PD1 including the first band data BD1 and the print setting related to the print data is the print setting A. In this case, the change section 160 decides not to change the longitudinal direction of the band data in the print data. On the other hand, in the above case, it is assumed that the print data is the print data PD1 including the first band data BD1 and the print setting related to the print data is the print setting B. In this case, the change section 160 changes the longitudinal direction of the first band data BD1 in the print data PD1, as indicated by an arrow Sa1 in FIG. 6. Further, in the above case, it is assumed that the print data is the print data PD2 including the second band data BD2 and the print setting related to the print data is the print setting A. In this case, the change section 160 changes the longitudinal direction of the second band data BD2 in the print data PD2, as indicated by an arrow Sa2 in FIG. 6.

The print data transmission section 170 transmits, to the second image forming apparatus 200, the print data subjected to the change processing of the longitudinal direction of the band data in the print data. The print data transmission section 170 may control the communication section 106 to transmit the print data to the second image forming apparatus 200. Further, the print data transmission section 170 transmits, to the second image forming apparatus 200, the print data related to the user who is successfully authenticated.

Specifically, when the first function information indicates "without change function" and the longitudinal direction of the band data in the print data does not match the longitudinal direction of the band data indicated by the second function information, the print data transmission section 170 transmits, to the second image forming apparatus 200, the print data in which the longitudinal direction of the band data in the print data is changed. On the other hand, when the first function information indicates "with change function", the print data transmission section 170 transmits, to the second image forming apparatus 200, the print data in which the longitudinal direction of the band data in the print data is not changed. Further, when the longitudinal direction of the band data in the print data matches the longitudinal direction of the band data indicated by the second function information, the print data transmission section 170 transmits, to the second image forming apparatus 200, the print data in which the longitudinal direction of the band data in the print data is not changed.

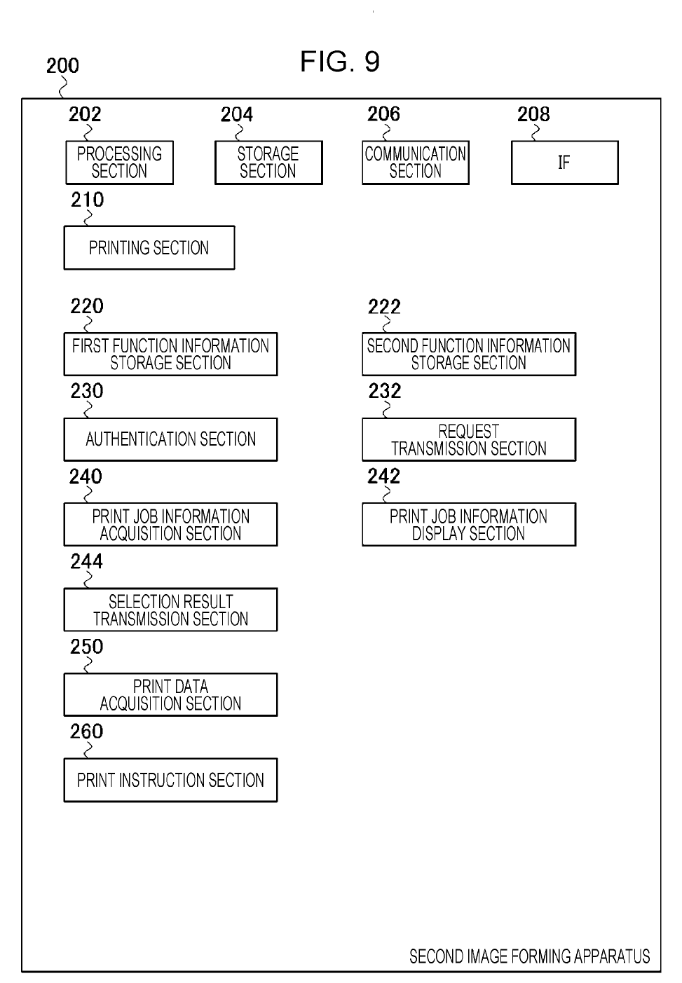

FIG. 9 is a diagram showing a configuration of the second image forming apparatus 200 according to Embodiment 1. The second image forming apparatus 200 includes a processing section 202, a storage section 204, a communication section 206, an interface section 208, and a printing section 210, as a main hardware configuration. The processing section 202, the storage section 204, the communication section 206, the interface section 208, and the printing section 210 may be coupled to each other, via a data bus or the like.

The processing section 202 is a processor such as a CPU. The processing section 202 may have a plurality of processors. The processing section 202 has a function as a calculation device that performs control processing, calculation processing, and the like. The processing section 202 controls the storage section 204, the communication section 206, the interface section 208, and the printing section 210.

The storage section 204 is a storage device such as a memory or a hard disk. The storage section 204 is, for example, a ROM or a RAM. The storage section 204 has a function of storing a control program, a calculation program, and the like, which are executed by the processing section 202. Further, the storage section 204 has a function of temporarily storing processing data and the like. The storage section 204 may include a database.

The communication section 206 performs processing necessary for the second image forming apparatus 200 to perform communication with another device, via the network 2. The communication section 206 may include a communication port, a router, a firewall, and the like. The communication section 206 performs processing for the second image forming apparatus 200 to perform communication with the terminal device 10 and the first image forming apparatus 100. The communication section 206 may perform processing for the second image forming apparatus 200 to perform communication with the terminal device 10 and the first image forming apparatus 100, via a LAN such as a wireless LAN. Further, the communication section 206 may perform processing for the second image forming apparatus 200 to perform communication with the terminal device 10 and the first image forming apparatus 100, via the Internet.

The interface section 208 is, for example, a user interface. The interface section 208 receives an operation to input data by the user of the second image forming apparatus 200, and outputs information to the user. The interface section 208 includes an input device such as a button, a keyboard, a touch panel, or a mouse, and an output device such as a display or a speaker. The interface section 208 may be configured to include the input device and the output device integrally. The interface section 208 receives an operation to input data by the user, and outputs information to the user. The interface section 208 includes the operation panel.

Further, the second image forming apparatus 200 includes a first function information storage section 220, a second function information storage section 222, an authentication section 230, and a request transmission section 232, as components. Further, the second image forming apparatus 200 includes a print job information acquisition section 240, a print job information display section 242, a selection result transmission section 244, a print data acquisition section 250, and a print instruction section 260, as components. The second image forming apparatus 200 may have an OS as basic software. Each component described above other than the OS may operate using a function of the OS. Further, the second image forming apparatus 200 may have substantially the same components as the components of first image forming apparatus 100 described above, as components. That is, the second image forming apparatus 200 may function as the host machine. This is the same in other embodiments described below.

Each component described above can be realized by, for example, execution of a program under the control of the processing section 202. More specifically, each component can be realized by the processing section 202 executing a program stored in the storage section 204. Further, a necessary program may be recorded on any non-volatile recording medium and installed as necessary to realize each component. These matters are the same in other embodiments.

Further, each component may be realized by any combination of hardware, firmware, and software, without being limited to being realized by software according to a program. Further, each component may be realized by using an integrated circuit, which is programmable by the user, such as an FPGA or a microcomputer. In this case, a program configured to include each component described above may be realized by using the integrated circuit. These matters are the same in other embodiments.

The first function information storage section 220 stores the first function information of the second image forming apparatus 200. The first function information storage section 220 may be realized by the storage section 204. When the second image forming apparatus 200 has the change function described with reference to FIG. 6, the first function information storage section 220 stores the first function information indicating that the second image forming apparatus 200 has the change function, that is, "with change function". On the other hand, when the second image forming apparatus 200 does not have the change function, the first function information storage section 220 stores the first function information indicating that the second image forming apparatus 200 does not have the change function, that is, "without change function".

The second function information storage section 222 stores the second function information of the second image forming apparatus 200. The second function information storage section 222 may be realized by the storage section 204. When the second image forming apparatus 200 processes the first band data BD1, the second function information storage section 222 stores the second function information indicating that the second image forming apparatus 200 processes the band data with the first direction D1 of the print target as the longitudinal direction, that is, "first band data BD1". When the second image forming apparatus 200 processes the second band data BD2, the second function information storage section 222 stores the second function information indicating that the second image forming apparatus 200 processes the band data with the second direction D2 of the print target as the longitudinal direction, that is, "second band data BD2". When the second image forming apparatus 200 processes the first band data BD1 and the second band data BD2, the second function information storage section 222 stores the second function information indicating "first band data BD1" and "second band data BD2". The second function information storage section 222 may store second function information indicating which of the first band data BD1 and the second band data BD2 is to be processed by the second image forming apparatus 200 for each print setting.

The authentication section 230 performs the authentication of the user. Specifically, the authentication section 230 determines that the user who attempts the authentication is a valid user of the second image forming apparatus 200. That is, the authentication section 230 determines whether or not the user who attempts the authentication is a user registered in advance. More specifically, the authentication section 230 acquires the identification information of the user who attempts the authentication by an operation of the interface section 208 by the user. The authentication section 230 determines whether or not the acquired identification information of the user is included in registration information registered in advance. The registration information may be stored in the second image forming apparatus 200, or may be stored in a server communicably coupled to the second image forming apparatus 200. When the registration information includes the acquired identification information of the user, the authentication section 230 determines that the authentication of the user is successful. On the other hand, when the registration information does not include the acquired identification information of the user, the authentication section 230 determines that the authentication of the user fails.

The request transmission section 232 transmits the print data request to the first image forming apparatus 100. The request transmission section 232 may control the communication section 206 to transmit the print data request to the first image forming apparatus 100. Specifically, when the user authentication is successful, the request transmission section 232 transmits, to the first image forming apparatus 100, the print data request requesting that the print data transmitted from the terminal device 10 to the first image forming apparatus 100 is transmitted to the second image forming apparatus 200. As described above, the print data request may include the user identification information, which is the identification information of the user who is successfully authenticated, and the submachine identification information, which is the identification information of the second image forming apparatus 200. Further, the print data request may include first function information and second function information of the second image forming apparatus 200.

The print job information acquisition section 240 acquires the print job information from the first image forming apparatus 100. The print job information acquisition section 240 may acquire the print job information with reception of the print job information from the first image forming apparatus 100 by the communication section 206. The print job information acquisition section 240 acquires, from the first image forming apparatus 100, the print job information related to the user who is successfully authenticated.

The print job information display section 242 performs processing for displaying the print job list indicated by the print job information. Specifically, the print job information display section 242 displays the print job list on the interface section 208 such as the operation panel. The user performs a selection operation of the print job on the print job list displayed on the interface section 208 by the print job information display section 242.

The selection result transmission section 244 transmits the selection result by the user to the first image forming apparatus 100. The selection result transmission section 244 may control the communication section 206 to transmit the selection result to the first image forming apparatus 100. As described above, the selection result indicates the print job selected by the user. Further, the selection result may include the first function information and the second function information of the second image forming apparatus 200. Further, the selection result may indicate a request for the print data related to the print job selected by the user.

The print data acquisition section 250 acquires the print data from the first image forming apparatus 100. The print data acquisition section 250 may acquire the print data with reception of the print data from the first image forming apparatus 100 by the communication section 206. When the authentication is successful, the print data acquisition section 250 acquires the print data related to the user who is successfully authenticated, from the first image forming apparatus 100 that acquires the print data from the terminal device 10. In the print data acquired by the print data acquisition section 250, the change processing, based on the longitudinal direction of the band data corresponding to the second image forming apparatus 200, is performed on the longitudinal direction of the band data in which the print target is divided. In other words, in the print data acquired by the print data acquisition section 250, the longitudinal direction of the band data may be changed according to the longitudinal direction of the band data processed by the second image forming apparatus 200.

For example, when the second image forming apparatus 200 does not have the change function, it is assumed that the longitudinal direction of the band data in the print data, which is acquired by the first image forming apparatus 100, does not match the longitudinal direction of the band data to be processed by the second image forming apparatus 200. In this case, the longitudinal direction of the band data in the print data acquired by the print data acquisition section 250 is changed according to the longitudinal direction of the band data to be processed by the second image forming apparatus 200. On the other hand, when the longitudinal direction of the band data in the print data acquired by the first image forming apparatus 100 matches the longitudinal direction of the band data to be processed by the second image forming apparatus 200, the longitudinal direction of the band data in the print data, which is acquired by the print data acquisition section 250, is not changed. Further, when the second image forming apparatus 200 has the change function, the longitudinal direction of the band data in the print data, which is acquired by the print data acquisition section 250, is not changed.

The print instruction section 260 instructs the printing section 210 to perform the printing of the acquired print data, and controls the printing section 210. Accordingly, the printing section 210 performs the printing of the acquired print data. As described above, in the print data to be printed by the printing section 210, the longitudinal direction of the band data is subjected to the change processing based on the longitudinal direction of the band data corresponding to the second image forming apparatus 200. Thus, the printing section 210 performs the printing of the print data in accordance with the function of the second image forming apparatus 200.

It is assumed that the second image forming apparatus 200 has the change function and the longitudinal direction of the band data in the print data does not match the longitudinal direction of the band data to be processed by the second image forming apparatus 200. In this case, the print instruction section 260 uses the change function to change the longitudinal direction of the band data in the print data. The print instruction section 260 instructs the printing section 210 to perform the printing of the print data in which the longitudinal direction of the band data is changed, and controls the printing section 210.

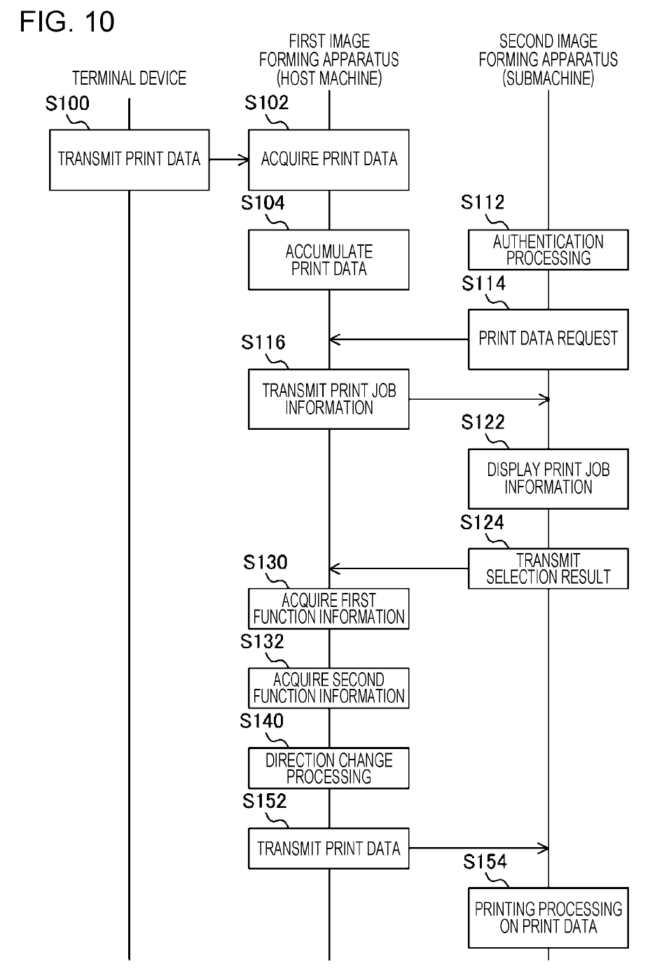

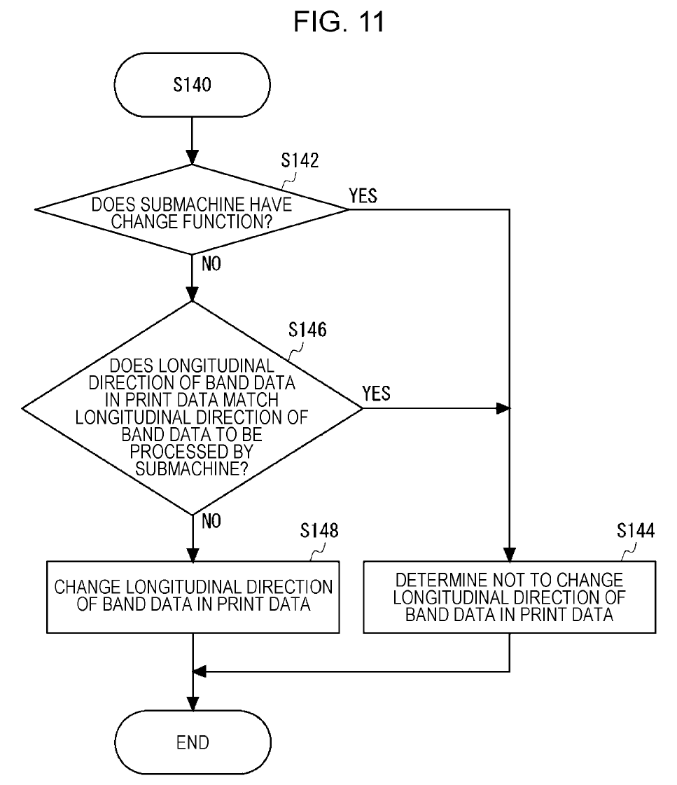

FIGS. 10 and 11 are diagrams showing the processing executed by the processing system 1 according to Embodiment 1. FIGS. 10 and 11 show a processing method executed by the first image forming apparatus 100. FIG. 10 is a sequence diagram showing the processing method executed by the processing system 1 according to Embodiment 1.

The terminal device 10 transmits the print data to the first image forming apparatus 100 (step S100). Specifically, as described above, the print data generation section 50 generates the print data. Further, the first print data transmission section 60 transmits the generated print data to the first image forming apparatus 100. In the first image forming apparatus 100, the print data acquisition section 130 acquires the print data from the terminal device 10, as described above (step S102). The print data accumulation section 132 accumulates the acquired print data, as described above (step S104).

In the second image forming apparatus 200, the authentication section 230 performs the authentication processing for the user, as described above (step S112). When the authentication is successful, the request transmission section 232 transmits the print data request to the first image forming apparatus 100, as described above (step S114). The first image forming apparatus 100 transmits the print job information, in response to the print data request (step S116). Specifically, the request acquisition section 140 acquires the print data request from the second image forming apparatus 200, as described above. The print job information transmission section 142 performs the processing of transmitting the print job information to the second image forming apparatus 200, as described above.

The second image forming apparatus 200 displays the print job information (step S122). Specifically, the print job information acquisition section 240 acquires the print job information from the first image forming apparatus 100, as described above. Further, the print job information display section 242 causes the interface section 208 to display the print job list indicated by the print job information. In the second image forming apparatus 200, the selection result transmission section 244 transmits the selection result by the user to the first image forming apparatus 100, as described above (step S124). Accordingly, the selection result acquisition section 144 of the first image forming apparatus 100 acquires the selection result of the print job, as described above.

In the first image forming apparatus 100, the first function information acquisition section 150 acquires the first function information of the second image forming apparatus 200, as described above (step S130). Further, in the first image forming apparatus 100, the second function information acquisition section 151 acquires the second function information of the second image forming apparatus 200, as described above (step S132). In the first image forming apparatus 100, the change section 160 performs the change processing of the longitudinal direction of the band data in the print data (step S140).

FIG. 11 is a flowchart showing details of the processing of S140. FIG. 11 shows the change processing by the change section 160. The change section 160 determines, by using the first function information, whether or not the second image forming apparatus 200, which is the submachine, has the change function (step S142). When the submachine has the change function (YES in S142), the change section 160 determines not to change the longitudinal direction of the band data in the print data (step S144). On the other hand, when the submachine does not have the change function (NO in S142), the change section 160 determines, by using the second function information, whether or not the longitudinal direction of the band data in the print data matches the longitudinal direction of the band data to be processed by the submachine (step S146). When the longitudinal direction of the band data in the print data matches the longitudinal direction of the band data to be processed by the submachine (YES in S146), the change section 160 performs the processing of S144 described above. That is, the change section 160 determines not to change the longitudinal direction of the band data in the print data. On the other hand, when the longitudinal direction of the band data in the print data does not match the longitudinal direction of the band data to be processed by the submachine (NO in S146), the change section 160 changes the longitudinal direction of the band data in the print data, as described above (step S148). Specifically, the change section 160 changes the longitudinal direction of the band data in the print data in accordance with the longitudinal direction of the band data to be processed by the submachine.

In the first image forming apparatus 100, the print data transmission section 170 transmits the print data after the change processing to the second image forming apparatus 200 (step S152). Accordingly, the print data acquisition section 250 of the second image forming apparatus 200 acquires the print data after the change processing. The second image forming apparatus 200 performs the printing processing on the print data (step S154). Specifically, in the second image forming apparatus 200, the print instruction section 260 instructs the printing section 210 to perform the printing of the acquired print data, as described above. Accordingly, the printing section 210 performs the printing of the acquired print data.

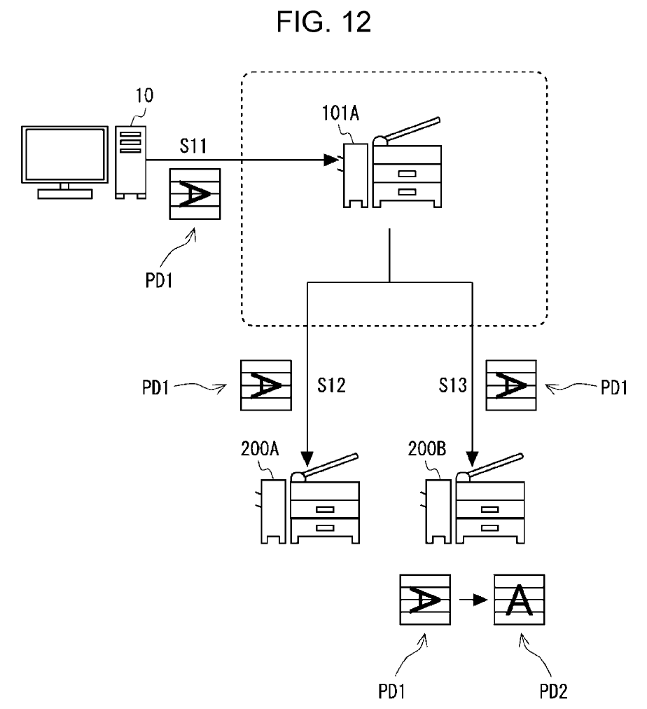

FIGS. 12 to 15 are diagrams for describing differences between comparative examples and Embodiment 1. FIG. 12 is a diagram for describing processing of a first image forming apparatus 101A according to a first comparative example. The first image forming apparatus 101A, which is the host machine, is assumed to process the first band data BD1. Further, a second image forming apparatus 200A, which is the submachine, is assumed to process the first band data BD1. Further, a second image forming apparatus 200B, which is the submachine, is assumed to be able to process the second band data BD2 and to have the change function described above.

As indicated by an arrow S11, the terminal device 10 transmits the print data PD1 including the first band data BD1 to the first image forming apparatus 101A. When the second image forming apparatus 200A requests the first image forming apparatus 101A for the print data, the first image forming apparatus 101A transmits the print data PD1 to the second image forming apparatus 200A, as indicated by an arrow S12. In this case, since the second image forming apparatus 200A can process the first band data BD1, the second image forming apparatus 200A can perform the printing processing by using the print data PD1. Therefore, an appropriate print result may be obtained.

On the other hand, when the second image forming apparatus 200B requests the first image forming apparatus 101A for the print data, the first image forming apparatus 101A transmits the print data PD1 to the second image forming apparatus 200B, as indicated by an arrow S13. The second image forming apparatus 200B processes the second band data BD2. Thus, the second image forming apparatus 200B performs the change processing on the print data PD1 to generate the print data PD2 including the second band data BD2. The second image forming apparatus 200B can perform the printing processing by using the print data PD2. Therefore, an appropriate print result may be obtained.

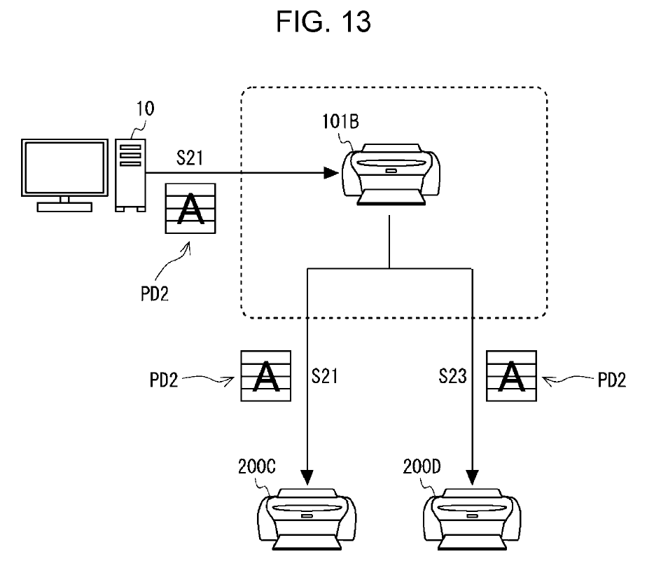

FIG. 13 is a diagram for describing processing of a first image forming apparatus 101B according to a second comparative example. The first image forming apparatus 101B, which is the host machine, is assumed to process the second band data BD2. Further, a second image forming apparatus 200C, which is the submachine, is assumed to process the second band data BD2. Further, it is assumed that a second image forming apparatus 200D, which is the submachine, processes the second band data BD2 and does not have the change function described above.

As indicated by an arrow S21, the terminal device 10 transmits the print data PD2 including the second band data BD2 to the first image forming apparatus 101B. When the second image forming apparatus 200C requests the first image forming apparatus 101B for the print data, the first image forming apparatus 101B transmits the print data PD2 to the second image forming apparatus 200C, as indicated by an arrow S22. In this case, since the second image forming apparatus 200C can process the second band data BD2, the second image forming apparatus 200C can perform the printing processing by using the print data PD2. Therefore, an appropriate print result may be obtained.

On the other hand, when the second image forming apparatus 200D requests the first image forming apparatus 101B for the print data, the first image forming apparatus 101B transmits the print data PD2 to the second image forming apparatus 200D, as indicated by an arrow S23. Since the second image forming apparatus 200D can process the second band data BD2, the second image forming apparatus 200D can perform the printing processing by using the print data PD2. Therefore, an appropriate print result may be obtained.

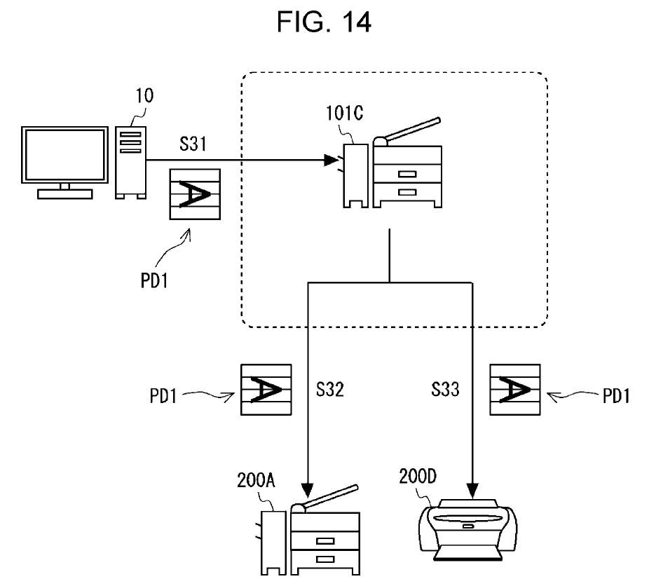

FIG. 14 is a diagram for describing processing of a first image forming apparatus 101C according to a third comparative example. The first image forming apparatus 101C, which is the host machine, is assumed to process the first band data BD1. Further, a second image forming apparatus 200A, which is the submachine, is assumed to process the first band data BD1. Further, it is assumed that a second image forming apparatus 200D, which is the submachine, processes the second band data BD2 and does not have the change function described above.

As indicated by an arrow S31, the terminal device 10 transmits the print data PD1 including the first band data BD1 to the first image forming apparatus 101C. When the second image forming apparatus 200A requests the first image forming apparatus 101C for the print data, the first image forming apparatus 101C transmits the print data PD1 to the second image forming apparatus 200A, as indicated by an arrow S32. In this case, since the second image forming apparatus 200A can process the first band data BD1, the second image forming apparatus 200A can perform the printing processing by using the print data PD1. Therefore, an appropriate print result may be obtained.

On the other hand, when the second image forming apparatus 200D requests the first image forming apparatus 101C for the print data, the first image forming apparatus 101C transmits the print data PD1 to the second image forming apparatus 200D, as indicated by an arrow S33. Since the second image forming apparatus 200D processes the second band data BD2, the printing processing cannot be performed by using the print data PD1. Further, since the second image forming apparatus 200D does not have the change function, the print data PD1 cannot be converted into the print data PD2. For this reason, there is a concern that an appropriate print result may not be obtained. As described above, in the comparative example, there is a concern that an appropriate print result may not be obtained depending on the function of the second image forming apparatus 200.

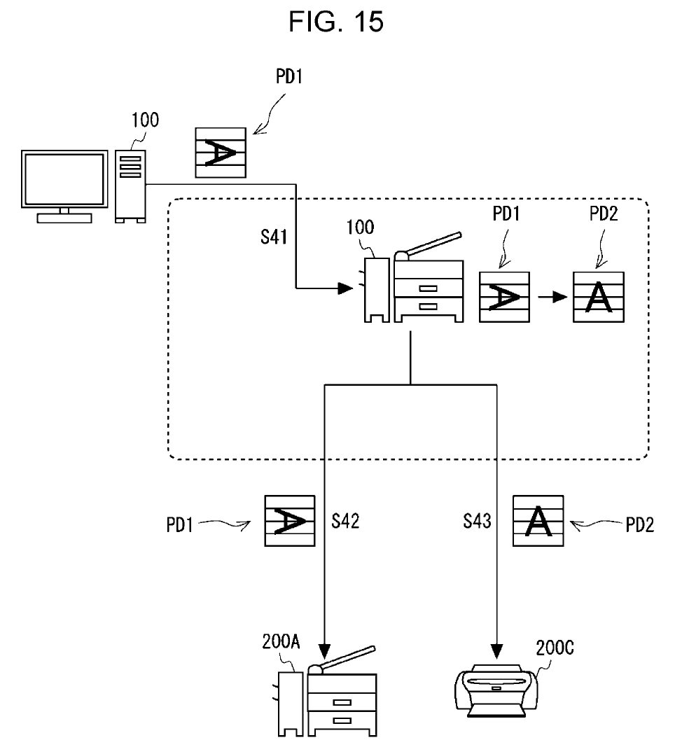

FIG. 15 is a diagram for describing processing performed by the first image forming apparatus 100 according to Embodiment 1. The first image forming apparatus 100 is assumed to process the first band data BD1. Further, the second image forming apparatus 200A, which is the submachine, is assumed to process the first band data BD1. Further, it is assumed that a second image forming apparatus 200D, which is the submachine, processes the second band data BD2 and does not have the change function described above.

As indicated by an arrow S41, the terminal device 10 transmits the print data PD1 including the first band data BD1 to the first image forming apparatus 100. The second image forming apparatus 200A is assumed to request the first image forming apparatus 100 for the print data. The second image forming apparatus 200A processes the first band data BD1. Thus, as indicated by an arrow S42, the first image forming apparatus 100 transmits the print data PD1 to the second image forming apparatus 200A as it is without performing the change processing on the print data PD1. In this case, since the second image forming apparatus 200A can process the first band data BD1, the second image forming apparatus 200A can perform the printing processing by using the print data PD1. Therefore, an appropriate print result may be obtained.

On the other hand, the second image forming apparatus 200D is assumed to request the first image forming apparatus 100 for the print data. The second image forming apparatus 200D processes the second band data BD2, which is different from the first band data BD1 of the print data PD1. Further, the second image forming apparatus 200D does not have the change function. Thus, the first image forming apparatus 100 performs the change processing on the print data PD1 to change the longitudinal direction of the band data in the print data PD1. Accordingly, the first image forming apparatus 100 generates the print data PD2 including the second band data BD2. As indicated by an arrow S43, the first image forming apparatus 100 transmits the print data PD2 to the second image forming apparatus 200D. Since the second image forming apparatus 200D can process the second band data BD2, the second image forming apparatus 200D can perform the printing processing by using the print data PD2. Therefore, an appropriate print result may be obtained.

As described above, the first image forming apparatus 100 according to Embodiment 1 performs the change processing of the longitudinal direction of the band data in the print data, in accordance with the comparison between the print data related to the band data acquired by the first image forming apparatus 100 and the function of the second image forming apparatus 200. Accordingly, the second image forming apparatus 200 according to Embodiment 1 can acquire the print data subjected to the change processing, in accordance with the function of the second image forming apparatus 200. Therefore, in Embodiment 1, an appropriate print result can be obtained, without depending on the longitudinal direction of the band data included in the print data acquired by the first image forming apparatus 100 and the function of the second image forming apparatus 200. Therefore, in Embodiment 1, convenience is improved as compared with the comparative example.

In Embodiment 1 described above, the print data request or the selection result, which is transmitted by the second image forming apparatus 200, is assumed to include the first function information and the second function information of the second image forming apparatus 200, but the present disclosure is not limited to such a configuration. The first image forming apparatus 100 may request the second image forming apparatus 200 to transmit the first function information and the second function information. On the other hand, since the print data request or the selection result, which is transmitted by the second image forming apparatus 200, includes the first function information and the second function information, there is no need for the first image forming apparatus 100 to request the second image forming apparatus 200 to transmit the first function information and the second function information. Therefore, the processing of the first image forming apparatus 100 is simplified.

### Embodiment 2

Next, Embodiment 2 will be described. For clarification of the description, the following description and drawings are omitted and simplified as appropriate. Further, in each drawing, the same reference numerals are assigned to the same elements, and redundant description thereof will be omitted as necessary. Thus, in the following description, parts different from those of Embodiment 1 described above will be mainly described. In Embodiment 2, a configuration of the processing system 1 is substantially the same as that of Embodiment 1, and thus description thereof will be omitted.

Further, in Embodiment 2, a configuration of the first image forming apparatus 100 may be substantially the same as that in Embodiment 1, and thus description thereof will be omitted. The first image forming apparatus 100 according to Embodiment 2 may not include the selection result acquisition section 144, the first function information acquisition section 150, the second function information acquisition section 151, the change section 160, and the print data transmission section 170, which are shown in FIG. 8. Here, Embodiment 2 is different from Embodiment 1 in that the second image forming apparatus 200 acquires the print data from the terminal device 10. That is, the terminal device 10 transmits the print data to the second image forming apparatus 200 in Embodiment 2.

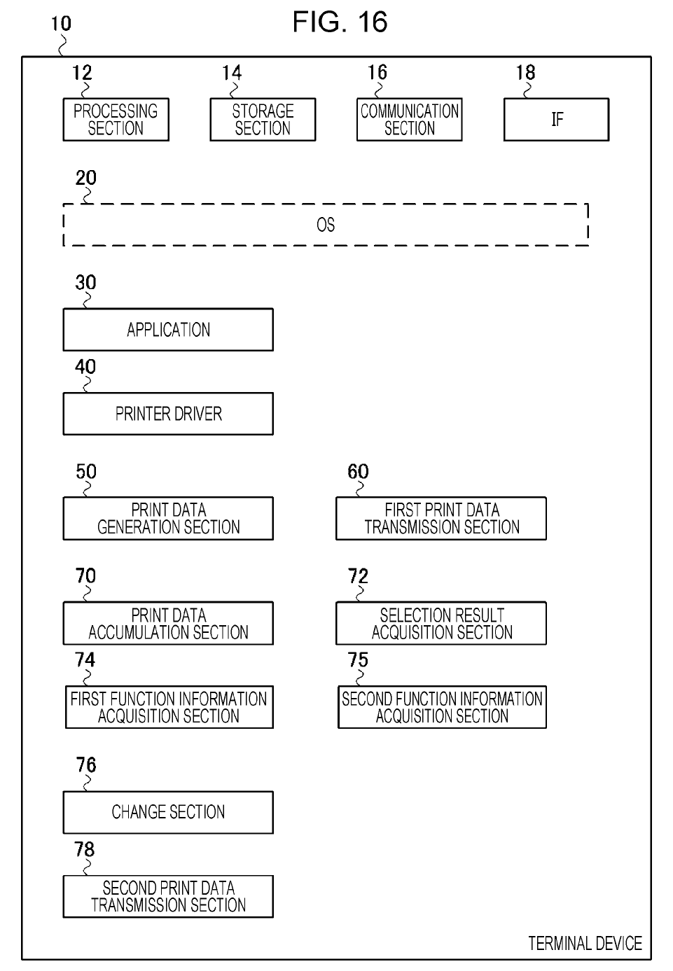

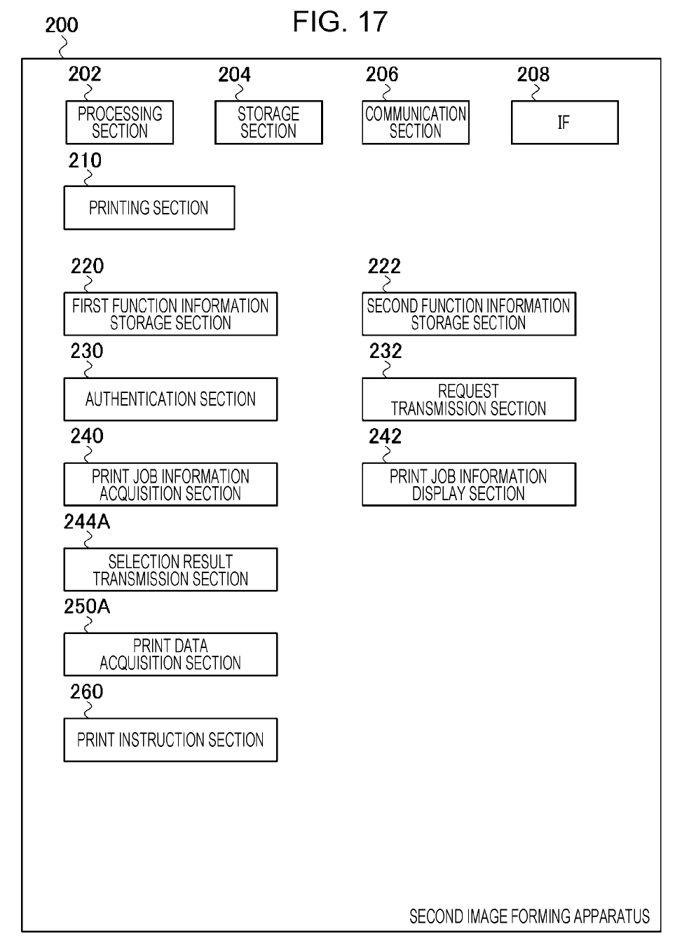

FIG. 16 is a diagram showing a configuration of the terminal device 10 according to Embodiment 2. As in the case of Embodiment 1 described above, the terminal device 10 according to Embodiment 2 has the processing section 12, the storage section 14, the communication section 16, and the interface section 18, as a main hardware configuration. Further, as in the case of Embodiment 1 described above, the terminal device 10 according to Embodiment 2 includes the OS 20, the application 30, the printer driver 40, the print data generation section 50, and the first print data transmission section 60, as components. Further, the terminal device 10 according to Embodiment 2 further includes a print data accumulation section 70, a selection result acquisition section 72, a first function information acquisition section 74, a second function information acquisition section 75, a change section 76, and a second print data transmission section 78. The OS 20, the application 30, the printer driver 40, the print data generation section 50, and the first print data transmission section 60 are substantially the same as those in Embodiment 1, and thus description thereof will be omitted.

The print data accumulation section 70 accumulates the print data transmitted by the first print data transmission section 60 to the first image forming apparatus 100. The print data accumulation section 70 may be realized by the storage section 14. Further, the print data accumulation section 70 may be realized by a spooler.

The selection result acquisition section 72 may have substantially the same function as the selection result acquisition section 144 described above. The selection result acquisition section 72 acquires the selection result of the print job from the second image forming apparatus 200. The selection result acquisition section 72 may acquire the selection result with reception of the selection result from the second image forming apparatus 200 by the communication section 16. The selection result may include the first function information and the second function information of the second image forming apparatus 200. Further, the selection result may indicate the print data request for the print job selected by the user. In this case, the selection result acquisition section 72 may function as a request acquisition section that acquires, from the second image forming apparatus, the print data request acquired by the first image forming apparatus 100.

The first function information acquisition section 74 may have substantially the same function as the first function information acquisition section 150 described above. The first function information acquisition section 74 acquires first function information related to the second image forming apparatus 200. When the selection result includes the first function information, the first function information acquisition section 74 may acquire the first function information from the selection result. Further, the first function information acquisition section 74 may acquire the first function information from the second image forming apparatus 200, separately from the selection result. Further, the first function information acquisition section 74 may acquire the first function information, in response to the acquisition of the selection result.

The second function information acquisition section 75 may have substantially the same function as the second function information acquisition section 151 described above. The second function information acquisition section 75 acquires the second function information related to the second image forming apparatus 200. When the selection result includes the second function information, the second function information acquisition section 75 may acquire the second function information from the selection result. Further, the second function information acquisition section 75 may acquire the second function information from the second image forming apparatus 200, separately from the selection result. Further, the second function information acquisition section 75 may acquire the second function information, in response to the acquisition of the selection result.

The change section 76 may have substantially the same function as the change section 160 described above. The change section 76 performs the change processing of the longitudinal direction of the band data in the acquired print data. In other words, the change section 76 performs the change processing of the longitudinal direction of the band data in the print data, which corresponds to the print job indicated by the selection result. The change section 76 performs the change processing on the print data stored in the print data accumulation section 70. Specifically, the change section 76 performs the change processing of the longitudinal direction of the band data in the print data, based on the first function information. Further, the change section 76 performs the change processing of the longitudinal direction of the band data in the print data, based on the second function information. That is, the change section 76 compares the longitudinal direction of the band data in the print data with the longitudinal direction of the band data indicated by the second function information. The change section 76 performs the change processing of the longitudinal direction of the band data in the print data, based on a result of the comparison.

More specifically, when the second image forming apparatus 200 can change the longitudinal direction of the band data in the print data, the change section 76 decides not to change the longitudinal direction of the band data in the print data. Further, when the longitudinal direction of the band data in the print data matches the longitudinal direction of the band data indicated by the second function information, the change section 76 decides not to change the longitudinal direction of the band data in the print data. On the other hand, when the second image forming apparatus 200 cannot change the longitudinal direction of the band data in the print data, and when the longitudinal direction of the band data in the print data does not match the longitudinal direction of the band data indicated by the second function information, the change section 76 changes the longitudinal direction of the band data in the print data.

The second print data transmission section 78 may have substantially the same function as the print data transmission section 170 described above. The second print data transmission section 78 may control the communication section 16 to transmit the print data to the second image forming apparatus 200. When the first function information indicates "without change function" and the longitudinal direction of the band data in the print data does not match the longitudinal direction of the band data indicated by the second function information, the second print data transmission section 78 transmits, to the second image forming apparatus 200, the print data in which the longitudinal direction of the band data in the print data is changed. On the other hand, when the first function information indicates "with change function", the second print data transmission section 78 transmits, to the second image forming apparatus 200, the print data in which the longitudinal direction of the band data in the print data is not changed. Further, when the longitudinal direction of the band data in the print data matches the longitudinal direction of the band data indicated by the second function information, the second print data transmission section 78 transmits, to the second image forming apparatus 200, the print data in which the longitudinal direction of the band data in the print data is not changed.

FIG. 17 is a diagram showing a configuration of the second image forming apparatus 200 according to Embodiment 2. As in the case of Embodiment 1 described above, the second image forming apparatus 200 according to Embodiment 2 has the processing section 202, the storage section 204, the communication section 206, the interface section 208, and the printing section 210, as a main hardware configuration. Further, as in the case of Embodiment 1 described above, the second image forming apparatus 200 according to Embodiment 2 includes the first function information storage section 220, the second function information storage section 222, the authentication section 230, the request transmission section 232, the print job information acquisition section 240, the print job information display section 242, and the print instruction section 260, as components. Further, the second image forming apparatus 200 according to Embodiment 2 includes a selection result transmission section 244A and a print data acquisition section 250A, instead of the selection result transmission section 244 and the print data acquisition section 250. Among the components of the second image forming apparatus 200 according to Embodiment 2, the components other than the selection result transmission section 244A and the print data acquisition section 250A are substantially the same as those of Embodiment 1, and thus description thereof will be omitted.

The selection result transmission section 244A transmits the selection result by the user to the terminal device 10. The selection result transmission section 244A may control the communication section 206 to transmit the selection result to the terminal device 10. Since other functions of the selection result transmission section 244A are substantially the same as functions of the selection result transmission section 244, description thereof will be omitted.

The print data acquisition section 250A acquires print data from the terminal device 10. The print data acquisition section 250A may acquire the print data with reception of the print data from the terminal device 10 by the communication section 206. When the authentication is successful, the print data acquisition section 250A acquires, from the terminal device 10, the print data related to the user who is successfully authenticated. In the print data acquired by the print data acquisition section 250A, the change processing, based on the longitudinal direction of the band data corresponding to the second image forming apparatus 200, is performed on the longitudinal direction of the band data in which the print target is divided.

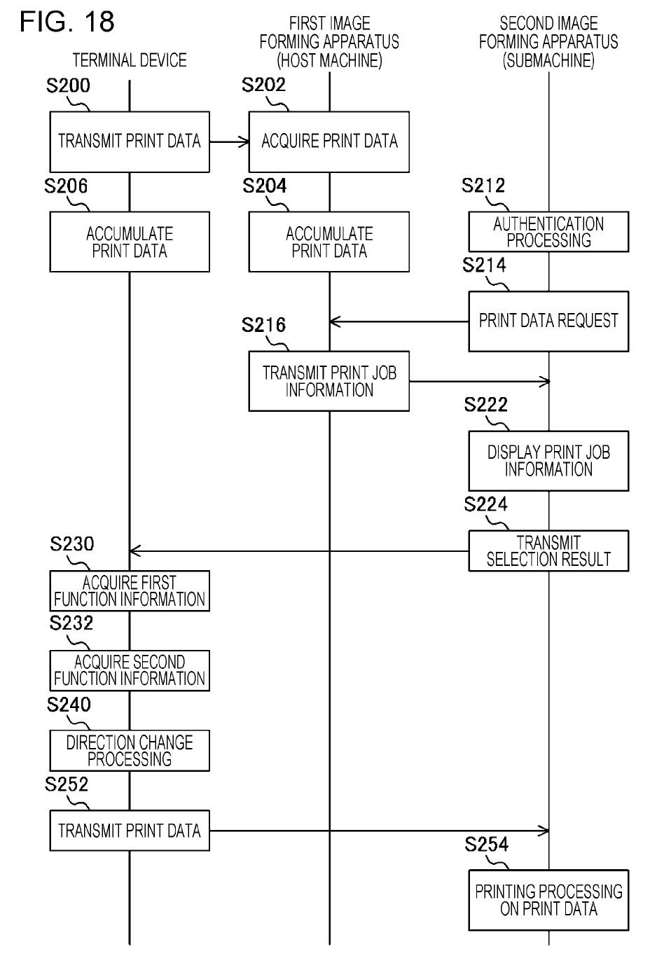

FIG. 18 is a diagram showing processing executed by the processing system 1 according to Embodiment 2. FIG. 18 shows a processing method executed by the second image forming apparatus 200. FIG. 18 is a sequence diagram showing the processing method executed by the processing system 1 according to Embodiment 2.

As in the processing of S100 shown in FIG. 10 described above, the terminal device 10 transmits the print data to the first image forming apparatus 100 (step S200). Further, as in the processing of S102 shown in FIG. 10 described above, in the first image forming apparatus 100, the print data acquisition section 130 acquires the print data from the terminal device 10 (step S202). The print data accumulation section 132 accumulates the acquired print data (step S204). Further, in the terminal device 10, the print data accumulation section 70 accumulates the print data transmitted to the first image forming apparatus 100, as described above (step S206).

As in the processing of S112 shown in FIG. 10 described above, in the second image forming apparatus 200, the authentication section 230 performs the authentication processing for the user (step S212). When the authentication is successful, the request transmission section 232 transmits the print data request to the first image forming apparatus 100 (step S214). As in the processing of S116 shown in FIG. 10 described above, the first image forming apparatus 100 transmits the print job information, in response to the print data request (step S216).

As in the processing of S122 shown in FIG. 10 described above, the second image forming apparatus 200 displays the print job information (step S222). In the second image forming apparatus 200, the selection result transmission section 244A transmits the selection result by the user to the terminal device 10, as described above (step S224). Accordingly, the selection result acquisition section 72 of the terminal device 10 acquires the selection result of the print job, as described above. Further, in the terminal device 10, the first function information acquisition section 74 acquires the first function information of the second image forming apparatus 200, as described above (step S230). In the terminal device 10, the second function information acquisition section 75 acquires the second function information of the second image forming apparatus 200, as described above (step S232).

The terminal device 10 performs the change processing of the longitudinal direction of the band data in the print data, in substantially the same manner as the processing shown in FIG. 11 (step S240). Specifically, as in the processing of S142 shown in FIG. 11 described above, the change section 76 determines whether or not the second image forming apparatus 200, which is the submachine, has the change function by using the first function information. When the submachine has the change function, the change section 76 determines not to change the longitudinal direction of the band data in the print data, as in the processing of S144 shown in FIG. 11 described above. On the other hand, when the submachine does not have the change function, the change section 76 determines whether or not the longitudinal direction of the band data in the print data matches the longitudinal direction of the band data to be processed by the second image forming apparatus 200, which is the submachine, as in the processing of S146 shown in FIG. 11 described above. When the longitudinal direction of the band data in the print data matches the longitudinal direction of the band data to be processed by the submachine, the change section 76 determines not to change the longitudinal direction of the band data in the print data, as in the processing of S144 shown in FIG. 11 described above. On the other hand, when the longitudinal direction of the band data in the print data does not match the longitudinal direction of the band data to be processed by the submachine, the change section 76 changes the longitudinal direction of the band data in the print data, as in the processing of S148 shown in FIG. 11 described above. Specifically, the change section 76 changes the longitudinal direction of the band data in the print data, in accordance with the longitudinal direction of the band data to be processed by the submachine.

In the terminal device 10, the second print data transmission section 78 transmits, to the second image forming apparatus 200, the print data after the change processing (step S252). Accordingly, the print data acquisition section 250A of the second image forming apparatus 200 acquires the print data after the change processing. As in the processing of S154 shown in FIG. 10 described above, the second image forming apparatus 200 performs the printing processing on the print data (step S254).

As in the case of Embodiment 1, the second image forming apparatus 200 according to Embodiment 2 can acquire the print data subjected to the change processing, in accordance with the function of the second image forming apparatus 200. Therefore, in Embodiment 2, as in the case of Embodiment 1, an appropriate print result can be obtained without depending on the longitudinal direction of the band data included in the print data acquired by the first image forming apparatus 100 and the function of the second image forming apparatus 200. Therefore, in Embodiment 2, convenience is improved as in the case of Embodiment 1.

In Embodiment 2 described above, the selection result, which is transmitted by the second image forming apparatus 200, is assumed to include the first function information and the second function information of the second image forming apparatus 200, but the present disclosure is not limited to such a configuration. The terminal device 10 may request the second image forming apparatus 200 to transmit the first function information and the second function information. On the other hand, since the selection result, which is transmitted by the second image forming apparatus 200, includes the first function information and the second function information, there is no need for the terminal device 10 to request the second image forming apparatus 200 to transmit the first function information and the second function information. Therefore, the processing of the terminal device 10 is simplified.

### Embodiment 3

Next, Embodiment 3 will be described. For clarification of the description, the following description and drawings are omitted and simplified as appropriate. Further, in each drawing, the same reference numerals are assigned to the same elements, and redundant description thereof will be omitted as necessary. Thus, in the following description, parts different from those of Embodiment 1 described above will be mainly described. In Embodiment 3, a configuration of the processing system 1 is substantially the same as that of Embodiment 1, and thus description thereof will be omitted.

Further, in Embodiment 3, configurations of the terminal device 10 and the second image forming apparatus 200 may be substantially the same as those in Embodiment 1, respectively, and thus description thereof will be omitted. Embodiment 3 is different from Embodiment 1 in that the first image forming apparatus 100 determines the function (first function and second function) of the second image forming apparatus 200. That is, in Embodiment 3, the first image forming apparatus 100 determines whether or not the second image forming apparatus 200 has the change function and which band data the second image forming apparatus 200 processes. Thus, in Embodiment 3, the print data request and the selection result may not include the first function information and the second function information. Further, in Embodiment 3, the first image forming apparatus 100 may not request the second image forming apparatus 200 for the first function information and the second function information.

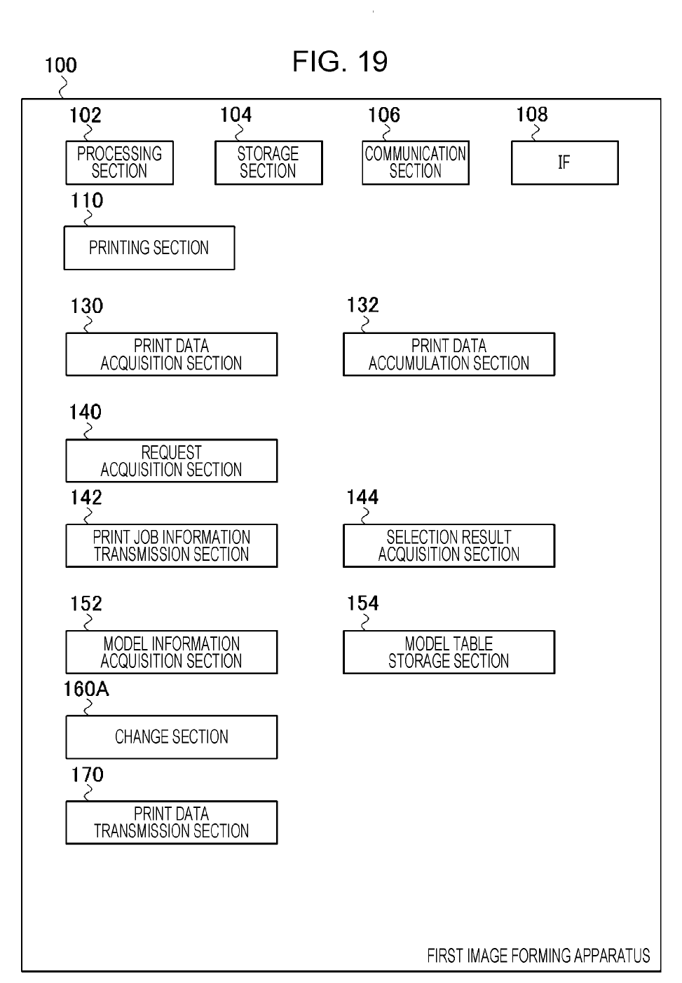

FIG. 19 is a diagram showing a configuration of the first image forming apparatus 100 according to Embodiment 3. As in the case of Embodiment 1 described above, the first image forming apparatus 100 according to Embodiment 3 has the processing section 102, the storage section 104, the communication section 106, the interface section 108, and the printing section 110, as a main hardware configuration. Further, the first image forming apparatus 100 according to Embodiment 3 has the print data acquisition section 130 and the print data accumulation section 132, as components, as in the case of Embodiment 1 described above. Further, the first image forming apparatus 100 according to Embodiment 3 includes the request acquisition section 140, the print job information transmission section 142, the selection result acquisition section 144, and the print data transmission section 170, as components. Further, the first image forming apparatus 100 according to Embodiment 3 includes a model information acquisition section 152, a model table storage section 154, and a change section 160A, instead of the first function information acquisition section 150, the second function information acquisition section 151, and the change section 160. Among the components of the first image forming apparatus 100 according to Embodiment 3, the components other than the model information acquisition section 152, the model table storage section 154, and the change section 160A are substantially the same as those of Embodiment 1, and thus description thereof will be omitted. In Embodiment 3, at least one of the print data request and the selection result acquired from the second image forming apparatus 200 by the first image forming apparatus 100 may indicate model information of the second image forming apparatus 200.

The model information acquisition section 152 acquires the model information of the second image forming apparatus 200 that transmits the print data request. The model information indicates a model of the second image forming apparatus 200. The model information may indicate, for example, a model number and a manufacturer name of the second image forming apparatus 200. When the model information is indicated in the print data request, the model information acquisition section 152 may acquire the model information from the print data request. When the model information is indicated by the selection result, the model information acquisition section 152 may acquire the model information from the selection result. Further, the model information acquisition section 152 may acquire the model information from the second image forming apparatus 200, separately from the print data request and the selection result. In this case, the model information acquisition section 152 may acquire the model information from the second image forming apparatus 200, in response to the acquisition of the request for the print data.

The model table storage section 154 stores a model table. The model table storage section 154 may be realized by the storage section 104. The model table indicates, for each model, whether or not the model has the change function and which band data the model processes. That is, the model table associates the model with the first function and the second function of the model. The model table storage section 154 may be provided in a device such as a server that is communicably coupled to the first image forming apparatus 100.

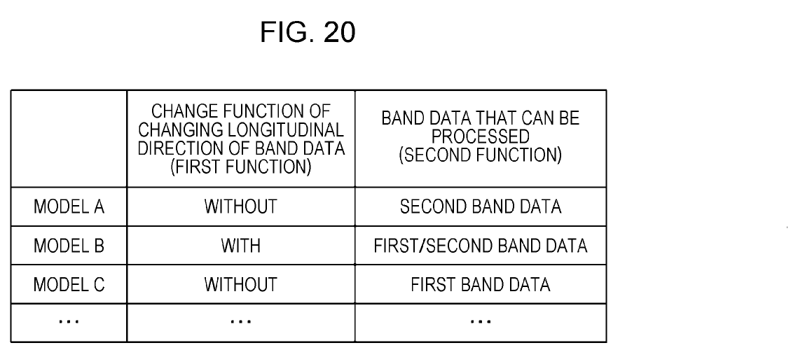

FIG. 20 is a diagram illustrating a model table according to Embodiment 3. In the example of FIG. 20, the model table indicates that a model A does not have the change function of changing the longitudinal direction of the band data in the print data, and that the band data that can be processed by the model A is "second band data BD2". Further, the model table indicates that a model B has the change function of changing the longitudinal direction of the band data in the print data, and that the band data that can be processed by the model B is "first band data BD1 and second band data BD2". Further, the model table indicates that a model C does not have the change function of changing the longitudinal direction of the band data in the print data, and that the band data that can be processed by the model C is "first band data BD1".

The change section 160A performs the change processing of the longitudinal direction of the band data in the print data, based on the model information. That is, the change section 160A performs the change processing of the longitudinal direction of the band data in the print data, which corresponds to the print job indicated by the selection result, based on the model information of the second image forming apparatus 200 that transmits the print data request. The change section 160A performs the change processing of the longitudinal direction of the band data on the print data, which is stored in the print data accumulation section 132, by using the model information and the model table.

Specifically, the change section 160A determines the first function and the second function of the second image forming apparatus 200, by using the model information acquired from the second image forming apparatus 200 and the model table. For example, in the example of FIG. 20, when the model information is indicated as "model A", the change section 160A determines that the second image forming apparatus 200 does not have the change function and can process the second band data BD2. Further, when the model information is indicated as "model B", the change section 160A determines that the second image forming apparatus 200 has the change function and can process the first band data BD1 and the second band data BD2. Further, when the model information is indicated as "model C", the change section 160A determines that the second image forming apparatus 200 does not have the change function and can process the first band data BD1.

The change section 160A performs the change processing of the longitudinal direction of the band data in the print data, based on the determined first function and second function. More specifically, when the second image forming apparatus 200 does not have the change function and the longitudinal direction of the band data in the print data does not match the longitudinal direction of the band data processed by the second image forming apparatus 200, the change section 160A changes the longitudinal direction of the band data in the print data. On the other hand, when the second image forming apparatus 200 has the change function, the change section 160A does not change the longitudinal direction of the band data in the print data. Further, when the longitudinal direction of the band data in the print data matches the longitudinal direction of the band data processed by the second image forming apparatus 200, the change section 160A does not change the longitudinal direction of the band data in the print data.

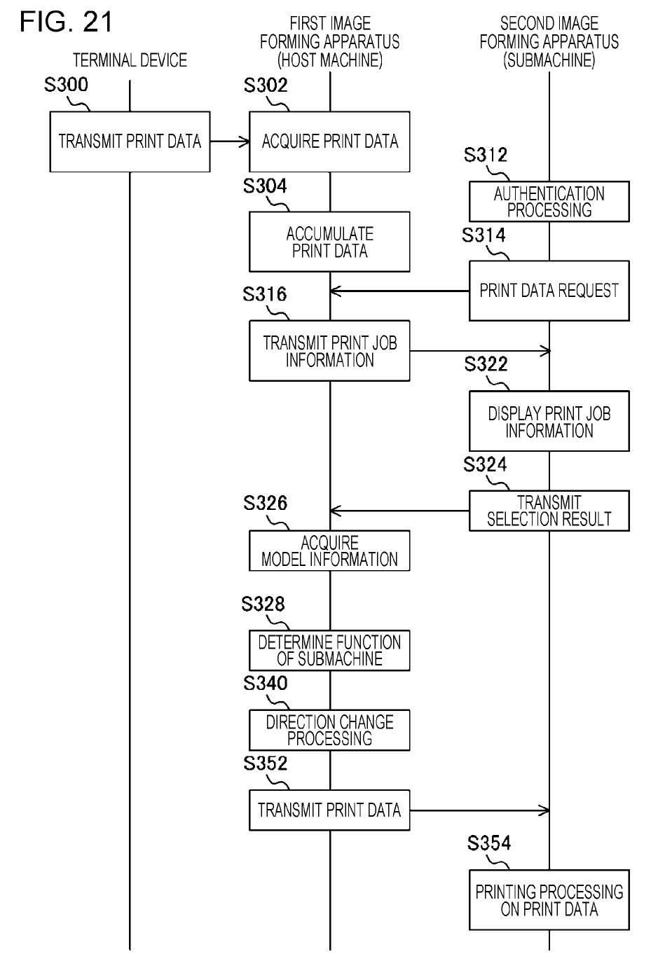

FIG. 21 is a diagram showing processing executed by the processing system 1 according to Embodiment 3. FIG. 21 shows a processing method executed by the first image forming apparatus 100. FIG. 21 is a sequence diagram showing the processing method executed by the processing system 1 according to Embodiment 3.

As in the processing of S100 shown in FIG. 10 described above, the terminal device 10 transmits the print data to the first image forming apparatus 100 (step S300). As in the processing of S102 shown in FIG. 10 described above, in the first image forming apparatus 100, the print data acquisition section 130 acquires the print data from the terminal device 10 (step S302). The print data accumulation section 132 accumulates the acquired print data (step S304).

As in the processing of S112 shown in FIG. 10 described above, in the second image forming apparatus 200, the authentication section 230 performs the authentication processing for the user (step S312). When the authentication is successful, the request transmission section 232 transmits the print data request to the first image forming apparatus 100 (step S314). As in the processing of S116 shown in FIG. 10 described above, the first image forming apparatus 100 transmits the print job information, in response to the print data request (step S316).

As in the processing of S122 shown in FIG. 10 described above, the second image forming apparatus 200 displays the print job information (step S322). As in the processing of S124 shown in FIG. 10 described above, in the second image forming apparatus 200, the selection result transmission section 244 transmits the selection result to the first image forming apparatus 100 (step S324). Accordingly, the selection result acquisition section 144 of the first image forming apparatus 100 acquires the selection result of the print job, as described above.

In the first image forming apparatus 100, the model information acquisition section 152 acquires the model information, as described above (step S326). As described above, the change section 160A determines the function of the second image forming apparatus 200, which is the submachine, based on the model information (step S328). Specifically, the change section 160A determines the first function and the second function of the second image forming apparatus 200, based on the model information. The change section 160A performs the change processing of the longitudinal direction of the band data in the print data (step S340). The change section 160A performs substantially the same processing as the processing of the flowchart shown in FIG. 11.

As in the processing of S152 shown in FIG. 10 described above, in the first image forming apparatus 100, the print data transmission section 170 transmits the print data after the change processing to the second image forming apparatus 200 (step S352). Accordingly, the print data acquisition section 250 of the second image forming apparatus 200 acquires the print data after the change processing. As in the processing of S154 shown in FIG. 10 described above, the second image forming apparatus 200 performs the printing processing on the print data (step S354).

As in the case of Embodiment 1, the second image forming apparatus 200 according to Embodiment 3 can acquire the print data subjected to the change processing, in accordance with the function of the second image forming apparatus 200. Therefore, in Embodiment 3, as in Embodiment 1, an appropriate print result can be obtained, without depending on the longitudinal direction of the band data included in the print data acquired by the first image forming apparatus 100 and the function of the second image forming apparatus 200. Therefore, in Embodiment 3, convenience is improved as in the case of Embodiment 1. Further, in Embodiment 3, an appropriate print result can be obtained with the print data request and the selection result not including the first function information and the second function information.

### First Modification Example of Embodiment 3

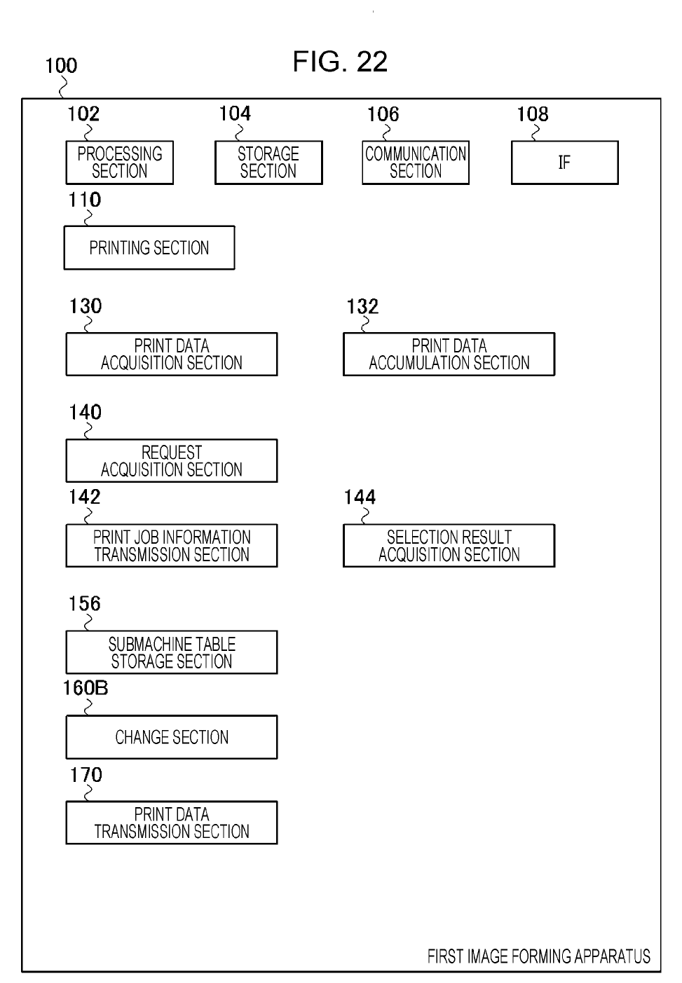

FIG. 22 is a diagram showing a configuration of the first image forming apparatus 100 according to a first modification example of Embodiment 3. The first image forming apparatus 100 according to the first modification example includes a submachine table storage section 156 and a change section 160B, instead of the model information acquisition section 152, the model table storage section 154, and the change section 160A. Among the components of the first image forming apparatus 100 according to the first modification example, the components other than the submachine table storage section 156 and the change section 160B are substantially the same as those of Embodiment 3 described above, and thus description thereof will be omitted. In the first modification example, the print data request and the selection result may not indicate the model information of the second image forming apparatus 200. As described above, at least one of the print data request and the selection result indicates the submachine identification information, which is the identification information of the second image forming apparatus 200 that transmits the print data request.

The submachine table storage section 156 stores a submachine table. The submachine table storage section 156 may be realized by the storage section 104. The submachine table indicates, for each submachine, that is, for each second image forming apparatus 200, whether or not the second image forming apparatus 200 has the change function and which band data the second image forming apparatus 200 processes. That is, the submachine table associates the submachine with the first function and the second function of the submachine. In other words, the submachine table indicates the function information indicating the function of each second image forming apparatus 200. That is, the submachine table storage section 156 stores the function information of the second image forming apparatus 200. In other words, the first image forming apparatus 100 stores the function information of the second image forming apparatus 200. The submachine table may be stored in the first image forming apparatus 100 when initial communication setting is performed between the first image forming apparatus 100 and the second image forming apparatus 200. Further, the submachine table storage section 156 may be provided in a device such as a server that is communicably coupled to the first image forming apparatus 100.

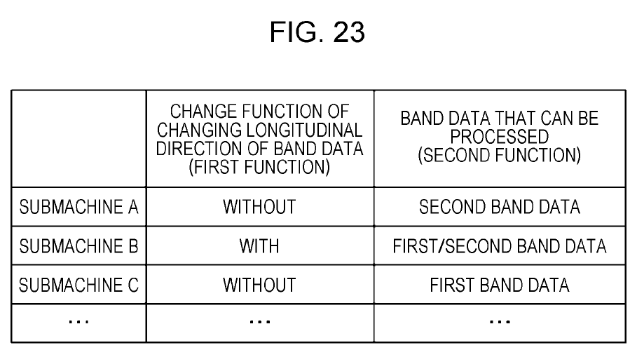

FIG. 23 is a diagram illustrating a submachine table according to the first modification example of Embodiment 3. In the example of FIG. 23, the submachine table indicates that a submachine A does not have the change function of changing the longitudinal direction of the band data in the print data, and that the band data that can be processed by the submachine A is "second band data BD2". Further, the submachine table indicates that a submachine B has the change function of changing the longitudinal direction of the band data in the print data, and that the band data that can be processed by the submachine B is "first band data BD1 and second band data BD2". Further, the submachine table indicates that a submachine C does not have the change function of changing the longitudinal direction of the band data in the print data, and that the band data that can be processed by the submachine C is "first band data BD1".

The change section 160B performs the change processing of the longitudinal direction of the band data in the print data, based on the submachine table stored in the first image forming apparatus 100, that is, the function information of the second image forming apparatus 200. The change section 160B performs the change processing of the longitudinal direction of the band data in the print data, which corresponds to the print job indicated by the selection result, based on the submachine identification information of the second image forming apparatus 200 that transmits the print data request. The change section 160B performs the change processing of the band data in the longitudinal direction on the print data, which is stored in the print data accumulation section 132, by using the submachine identification information of the second image forming apparatus 200 and the submachine table stored in the first image forming apparatus 100.

Specifically, the change section 160B determines the first function and the second function of the second image forming apparatus 200, by using the submachine identification information of the second image forming apparatus 200 and the submachine table. For example, in the example of FIG. 23, when the submachine identification information is indicated as "submachine A", the change section 160B determines that the second image forming apparatus 200 does not have the change function and can process the second band data BD2. Further, when the submachine identification information is indicated as "submachine B", the change section 160B determines that the second image forming apparatus 200 has the change function and can process the first band data BD1 and the second band data BD2. Further, when the submachine identification information is indicated as "submachine C", the change section 160B determines that the second image forming apparatus 200 does not have the change function and can process the first band data BD1.

The change section 160B performs the change processing of the longitudinal direction of the band data in the print data, based on the determined first function and second function. More specifically, when the second image forming apparatus 200 does not have the change function and the longitudinal direction of the band data in the print data does not match the longitudinal direction of the band data processed by the second image forming apparatus 200, the change section 160B changes the longitudinal direction of the band data in the print data. On the other hand, when the second image forming apparatus 200 has the change function, the change section 160B does not change the longitudinal direction of the band data in the print data. Further, when the longitudinal direction of the band data in the print data matches the longitudinal direction of the band data processed by the second image forming apparatus 200, the change section 160B does not change the longitudinal direction of the band data in the print data.

As described above, in the first modification example of Embodiment 3, the change section 160B is configured to perform the change processing of the longitudinal direction of the band data in the print data, based on the function information of the second image forming apparatus 200 stored in the first image forming apparatus 100. Accordingly, the first image forming apparatus 100 does not need to acquire, from the second image forming apparatus 200, the first function information and the second function information each time the print data request is acquired.

### Second Modification Example of Embodiment 3

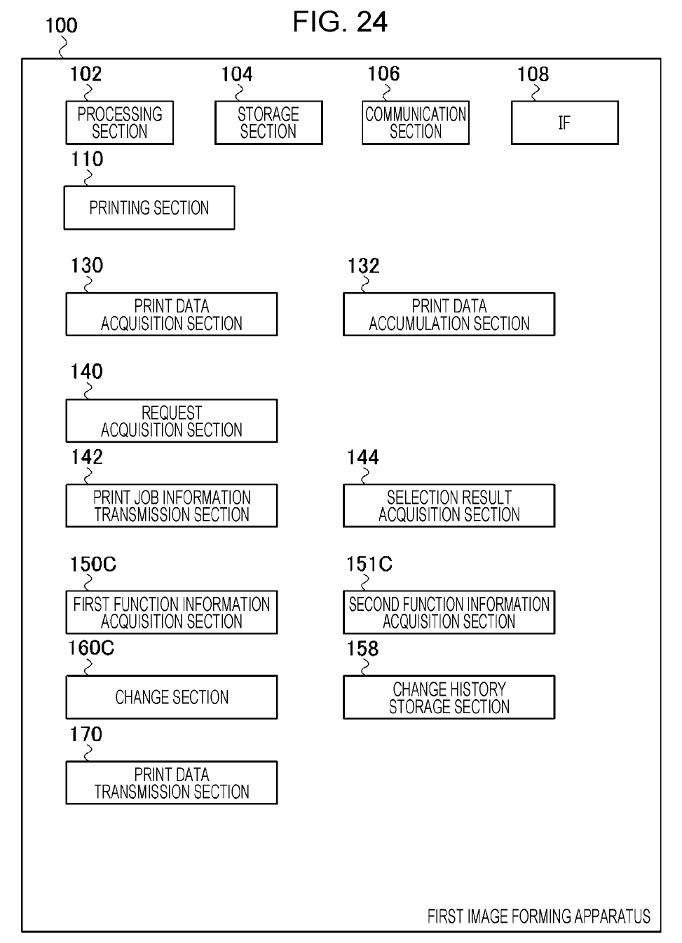

FIG. 24 is a diagram showing a configuration of the first image forming apparatus 100 according to a second modification example of Embodiment 3. The first image forming apparatus 100 according to the second modification example includes a first function information acquisition section 150C, a second function information acquisition section 151C, a change history storage section 158, and a change section 160C, instead of the model information acquisition section 152, the model table storage section 154, and the change section 160A. Among the components of the first image forming apparatus 100 according to the second modification example, the components other than the first function information acquisition section 150C, the second function information acquisition section 151C, the change history storage section 158, and the change section 160C are substantially the same as those of Embodiment 3 described above, and thus description thereof will be omitted. In the second modification example, the print data request and the selection result may not indicate the model information of the second image forming apparatus 200. As described above, at least one of the print data request and the selection result indicates the identification information of the second image forming apparatus 200 that transmits the print data request.

The first function information acquisition section 150C has substantially the same function as the first function information acquisition section 150 described above. However, it should be noted that the first function information acquisition section 150C may not acquire the first function information again from the second image forming apparatus 200 that acquires the first function information once.

The second function information acquisition section 151C has substantially the same function as the second function information acquisition section 151 described above. However, it should be noted that the second function information acquisition section 151C may not acquire the second function information again from the second image forming apparatus 200 that acquires the second function information once.

The change history storage section 158 stores a change history. The change history storage section 158 may be realized by the storage section 104. The change history is a history of the change processing of the longitudinal direction of the band data in the print data, for each submachine, that is, for each second image forming apparatus 200.

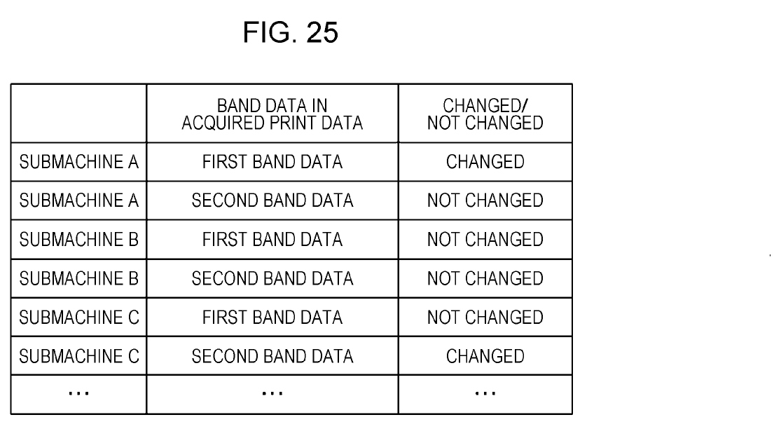

FIG. 25 is a diagram illustrating a change history according to the second modification example of Embodiment 3. In the example of FIG. 25, when the band data in the print data acquired by the first image forming apparatus 100 is the first band data BD1, the change history indicates that the longitudinal direction of the band data in the print data is changed, in the change processing for the submachine A. Further, when the band data in the print data acquired by the first image forming apparatus 100 is the second band data BD2, the change history indicates that the longitudinal direction of the band data in the print data is not changed, in the change processing for the submachine A.

Further, when the band data in the print data acquired by the first image forming apparatus 100 is the first band data BD1, the change history indicates that the longitudinal direction of the band data in the print data is not changed, in the change processing for the submachine B. Further, when the band data in the print data acquired by the first image forming apparatus 100 is the second band data BD2, the change history indicates that the longitudinal direction of the band data in the print data is not changed, in the change processing for the submachine B. Further, when the band data in the print data acquired by the first image forming apparatus 100 is the first band data BD1, the change history indicates that the longitudinal direction of the band data in the print data is not changed, in the change processing for the submachine C. Further, when the band data in the print data acquired by the first image forming apparatus 100 is the second band data BD2, the change history indicates that the longitudinal direction of the band data in the print data is changed, in the change processing for the submachine C.

The change section 160C performs the change processing of the longitudinal direction of the band data in the print data, based on the history of the change processing of the longitudinal direction of the band data in the print data. Specifically, in first change processing on certain band data of a certain second image forming apparatus 200, the change section 160 in Embodiment 1 performs substantially the same processing. That is, the change section 160C performs the change processing of the longitudinal direction of the band data in the print data, based on the first function information acquired by the first function information acquisition section 150C, the second function information acquired by the second function information acquisition section 151C, and the longitudinal direction of the band data in the print data. The change section 160C stores the history of the change processing in the change history storage section 158.

On the other hand, in second and subsequent change processing on certain band data of the second image forming apparatus 200, the change section 160C performs the change processing of the longitudinal direction of the band data in the print data, by using the change history stored in the change history storage section 158. For example, in the example of FIG. 25, when the second image forming apparatus 200 that transmits the print data request is the submachine B, the change section 160C determines not to change the longitudinal direction of the band data in the print data with reference to the change history.

Further, when the second image forming apparatus 200 that transmits the print data request is the submachine A and the band data in the print data is the first band data BD1, the change section 160C changes the longitudinal direction of the band data in the print data with reference to the change history. Further, when the second image forming apparatus 200 that transmits the print data request is the submachine A and the band data in the print data is the second band data BD2, the change section 160C determines not to change the longitudinal direction of the band data in the print data with reference to the change history.

Further, when the second image forming apparatus 200 that transmits the print data request is the submachine C and the band data in the print data is the first band data BD1, the change section 160C determines not to change the longitudinal direction of the band data in the print data with reference to the change history. Further, when the second image forming apparatus 200 that transmits the print data request is the submachine C and the band data in the print data is the second band data BD2, the change section 160C changes the longitudinal direction of the band data in the print data with reference to the change history.

As described above, in the second modification example of Embodiment 3, the change section 160C is configured to change the longitudinal direction of the band data in the print data, based on the history of the change processing of the longitudinal direction of the band data in the print data, which is stored in the first image forming apparatus 100. Accordingly, the first image forming apparatus 100 does not need to acquire, from the second image forming apparatus 200, the first function information and the second function information each time the print data request is acquired.

### Modification Example

The present disclosure is not limited to the above embodiments, and can be changed as appropriate within a range without departing from the gist. For example, the order of each piece of processing in the sequence diagram and flowchart described above can be changed as appropriate. Further, the plurality of embodiments described above can be applied to each other. For example, Embodiment 3 can be applied not only to Embodiment 1 but also to Embodiment 2.

Further, one or more pieces of processing in the sequence diagram and flowchart described above may be omitted. For example, the order of the processing of S142 and the processing of S146 shown in FIG. 11 may be reversed. In this case, the change section 160 may perform the processing of S146, and may perform the processing of S142 when the longitudinal direction of the band data in the print data does not match the longitudinal direction of the band data to be processed by the submachine. Further, the processing of S130 may be performed at any timing before the processing of S142. Further, the processing of S132 may be performed at any timing before the processing of S146.

Further, in the above embodiment, when the print data is transmitted to the second image forming apparatus 200 that does not have the change function, the first image forming apparatus 100 changes the longitudinal direction of the band data in the print data. On the other hand, the terminal device 10 may always transmit, to the first image forming apparatus 100, the print data in accordance with the longitudinal direction of the band data that can be processed by the second image forming apparatus 200 that does not have the change function. For example, when the band data that can be processed by the second image forming apparatus 200 that does not have the change function is the first band data BD1, the terminal device 10 may always transmit, to the first image forming apparatus 100, the print data configured of the first band data BD1. When the first image forming apparatus 100 processes the second band data BD2 and performs the printing, the first image forming apparatus 100 may use the change function to convert the first band data BD1 into the second band data BD2 and perform the printing. Further, when the print data is requested from the second image forming apparatus 200 that has the change function and processes the second band data BD2, the first image forming apparatus 100 transmits, to the second image forming apparatus 200, the print data configured of the first band data BD1. The second image forming apparatus 200 may use the change function to convert the first band data BD1 into the second band data BD2 and perform the printing. Accordingly, the first image forming apparatus 100 does not need to change the longitudinal direction of the band data in the print data according to the function of the second image forming apparatus 200.

In the examples described above, the program includes a group of commands (or software codes) for causing a computer to perform one or more functions described in the embodiment when being read by the computer. The program may be stored in a non-transitory computer-readable medium or a physical storage medium. By way of non-limiting example, the computer-readable medium or the physical storage medium includes a random-access memory (RAM), a read-only memory (ROM), a flash memory, a solid-state drive (SSD), or another memory technology, a CD-ROM, a digital versatile disk (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. By way of non-limiting example, the transitory computer-readable medium or the communication medium includes a propagating signal in an electrical, optical, acoustic, or another form. Further, the program is included in a program product.

What is claimed is:

1. A first image forming apparatus comprising:
a print data acquisition section that acquires, from a terminal device, print data including any one of first band data, which is divided with a first direction of a print target as a longitudinal direction, and second band data, which is divided with a second direction intersecting the first direction of the print target as the longitudinal direction;
a change section that performs change processing of the longitudinal direction of band data in the acquired print data; and
a print data transmission section that transmits, to a second image forming apparatus, the print data subjected to the change processing of the longitudinal direction of the band data.

2. The first image forming apparatus according to claim 1, further comprising:
a first function information acquisition section that acquires first function information indicating whether or not the longitudinal direction of the band data in the print data is changeable by the second image forming apparatus, wherein
the change section performs the change processing of the longitudinal direction of the band data in the print data, based on the first function information.

3. The first image forming apparatus according to claim 1, further comprising:
a second function information acquisition section that acquires second function information indicating which of the first band data and the second band data the second image forming apparatus processes, wherein
the change section performs the change processing of the longitudinal direction of the band data in the print data, based on a result of comparison between the longitudinal direction of the band data in the print data and a longitudinal direction of band data indicated by the second function information.

4. The first image forming apparatus according to claim 3, wherein
the change section changes the longitudinal direction of the band data in the print data when the longitudinal direction of the band data in the print data is not changeable by the second image forming apparatus and when the longitudinal direction of the band data in the print data does not match the longitudinal direction of the band data indicated by the second function information.

5. The first image forming apparatus according to claim 1, further comprising:
a request acquisition section that acquires, from the second image forming apparatus, a request for the print data acquired by the first image forming apparatus, wherein
the change section determines whether or not to change the longitudinal direction of the band data in the print data, in response to the acquisition of the request.

6. The first image forming apparatus according to claim 5, wherein
the request acquisition section acquires the request from the second image forming apparatus when authentication of a user is successful in the second image forming apparatus.

7. The first image forming apparatus according to claim 6, wherein
the print data transmission section transmits, to the second image forming apparatus, print data related to the user who is successfully authenticated.

8. The first image forming apparatus according to claim 1, further comprising:
a model information acquisition section that acquires model information of the second image forming apparatus, wherein
the change section performs the change processing of the longitudinal direction of the band data in the print data, based on the model information.

9. The first image forming apparatus according to claim 1, wherein
the change section performs the change processing of the longitudinal direction of the band data in the print data, based on function information, which is stored in the first image forming apparatus, indicating a function of the second image forming apparatus.

10. The first image forming apparatus according to claim 1, wherein
the change section performs the change processing of the longitudinal direction of the band data in the print data, based on a history of the change processing of the longitudinal direction of the band data in the print data.

11. A second image forming apparatus comprising:
an authentication section that executes authentication of a user;
a print data acquisition section that acquires, when the authentication is successful, print data from a first image forming apparatus that acquires the print data from a terminal device or from the terminal device that transmits the print data to the first image forming apparatus; and
a printing section that performs printing of the acquired print data, wherein
change processing based on a longitudinal direction of band data corresponding to the second image forming apparatus is performed on a longitudinal direction of band data in which a print target is divided, in the print data acquired by the print data acquisition section.

12. A processing method executed by a first image forming apparatus, the processing method comprising:
acquiring, from a terminal device, print data including any one of first band data, which is divided with a first direction of a print target as a longitudinal direction, and second band data, which is divided with a second direction intersecting the first direction of the print target as the longitudinal direction;
performing change processing of the longitudinal direction of band data in the acquired print data; and
transmitting, to a second image forming apparatus, the print data subjected to the change processing of the longitudinal direction of the band data.
